(19) United States
(12) Patent Application Publication
(10) Pub. No.: US 2018/0314066 A1
(43) Pub. Date: Nov. 1, 2018

(54) GENERATING DIMMING MASKS TO ENHANCE CONTRAST BETWEEN COMPUTER-GENERATED IMAGES AND A REAL-WORLD VIEW

(71) Applicant: Microsoft Technology Licensing, LLC, Redmond, WA (US)

(72) Inventors: Cynthia S. BELL, Kirkland, WA (US); Joshua O. MILLER, Woodinville, WA (US); Sihui HE, Bellevue, WA (US)

(21) Appl. No.: 15/581,566

(22) Filed: Apr. 28, 2017

(51) Int. Cl. G02B 27/01; G06T 19/00; G06T 15/60; G09G 3/20; G09G 5/10

(52) U.S. Cl. CPC G02B 27/0172; G06T 19/006; G06T 15/60; G09G 3/2092; G02B 2027/0118; G09G 2320/066; G09G 2360/141; G09G 2360/144; G02B 2027/0141; G09G 5/10

(57) ABSTRACT

A near-eye-display system generates a dimming mask to enhance contrast between a computer-generated image and a real-world view. The system monitors eye tracking data to determine physical characteristics of the user's eye. Then, based on these physical characteristics, the system may generate and locate a dimming mask with relation to the CG image to decrease user perceived brightness of a real-world view at a location where the CG image is displayed. Specifically, the dimming mask affects an amount of light transmitted from a real-world object that is permitted to enter the user's eyes. The system uses the dimming mask to effectively “turn down” the brightness of the real-world view at specific regions of a composite view corresponding to the CG image. A size and transmittance level of the dimming mask may vary based upon the pupil size. A location of the dimming mask may vary based upon the gaze direction.

### BACKGROUND

Near-Eye-Display (NED) systems superimpose computer-generated images (“CG images”) over a user's perspective of a physical real-world environment (referred to herein as a “real-world view”). For example, a NED system may generate composite views to enable a user to visually perceive a real-world view simultaneously with user interface (UI) menus, rendered images corresponding to multi-dimensional models (e.g. 2D and/or 3D models of virtual objects), or any other type of CG image. User perceived image quality is highly dependent on relative brightness (e.g. luminance) between the CG images and the real-world view. Various circumstances may result in inadequate brightness such that the CG images being generated by the NED system may be only faintly perceptible or even totally imperceptible to the user. For example, in instances where a brightness of the CG images is substantially lower than a brightness of the real-world view, the user may have difficulty perceiving the CG images.

In some instances, increasing CG image brightness with respect to the real-world view to make the CG images more readily perceptible may be well within the NED hardware's capability. In other instances, the NED hardware may be unable to reach a brightness level required for the CG images to become perceptible against the brightness of real-world view. In these instances, the NED would become less useful. Additionally, increasing the brightness of the CG images has numerous drawbacks, such as increasing the power draw of a NED system. Also, CG images are perceptually additive to the user's visual field and in some instances real world objects remain visible through CG imagery. Thus, CG objects do not appear solid and are sometimes described as having a “ghostly” appearance. Merely increasing the brightness of the CG images may also be ineffective at preventing these images from appearing as “ghostly images” as CG image brightness contributes to the eye's pupil response. Moreover, in instances where the CG images correspond to a rendered image of a virtual object being augmented into the real-world view, increasing the brightness of the rendered image (e.g. to overpower real world object brightness) may cause the virtual object to appear unnatural to the user. Such techniques may also present a number of inefficiencies with respect to the use of computing resources and energy resources.

It is with respect to these considerations and others that the disclosure made herein is presented.

### SUMMARY

Technologies described herein enable systems to generate dimming masks to enhance image quality of computer-generated images (“CG images”) within a real-world view. Generally described, the techniques disclosed herein enable a system to monitor eye tracking data to determine physical characteristics of a user's eye(s) (such as pupil diameter and/or gaze direction) and, based thereon, generate dimming masks with relation to CG images to decrease user perceived brightness of a real-world view (i.e. brightness of the real-world view from a user's perspective) in shaped regions where corresponding CG images are being rendered. Unlike conventional NED systems, the systems and techniques described herein are not limited to managing relative brightness between CG images and a real-world view by controlling the single variable of CG image brightness, which suffers from those drawbacks outlined above in addition to other drawbacks. Rather, the presently disclosed NED system is configured to control a perceived brightness of a real-world view with respect to CG images displayed to a user. In particular, the techniques described herein enable NED systems to dynamically alter optical properties of a transparent dimming panel to generate one or more dimming masks having a transmittance level that is less than a base transmittance of the transparent dimming panel.

As used herein, the term “contrast” may refer generally to a relationship between a luminance of one or more features of a CG image and a luminance of one or more features of a real-world view. For example, in some instances, contrast may correspond to “Weber” contrast which is defined as (I−I_{b})/I_{b} where I represents the luminance of the one or more features of the CG image and I_{b} represents the luminance of the one or more features of the real-world view.

As used herein, a “transmittance level” refers generally to a proportion of incident light that propagates entirely through a physical object such as, for example, the transparent dimming panel and/or transparent display described herein. For example, a transmittance level of zero-percent corresponds to a fully opaque physical object (i.e. an object through which zero-percent of visible light is able to pass) whereas a transmittance level of one-hundred-percent corresponds to a fully transparent physical object (i.e. an object through which one-hundred-percent of visible light is able to pass). As used herein, a “base transmittance” may refer generally to a foundational level of transmittance of a physical object having transmittance level control capabilities that enable the controlled increase and/or decrease of a transmittance level of one or more regions of the physical object. Techniques described herein provide for the generation of a dimming mask(s) on a transparent dimming panel having a base transmittance wherein the dimming mask(s) may have a lower transmittance level than the base transmittance, e.g. the dimming mask(s) is more opaque than other areas of the transparent dimming panel.

For illustrative purposes, consider a scenario where an augmented reality (AR) program instructs a Near-Eye-Display (NED) device to generate a composite view by superimposing a rendered image of a virtual object over some portion of a real-world view. For example, the AR program may cause the NED device to give the appearance that a soda can (e.g. the virtual object) is resting on top of a table that actually exists in the real-world environment and, therefore, is part of the real-world view. Suppose also that the real-world environment is sufficiently bright such that achieving a suitable relative brightness between the virtual object and the actual table would require the virtual object to be rendered at a brightness level that is unnaturally high or even beyond the capability or power budget of the NED. Under these exemplary circumstances, the techniques described herein enable the NED device to render the virtual object at a brightness level that appears natural with respect to the real-world environment while achieving the desired contrast by effectively “turning down” the brightness of the real-world view. In another instance, suppose that the real-world view includes a very bright object in the region where the virtual object is to be rendered. Under these circumstances, it is desirable to block nearly all light at the specific region where the virtual object is being displayed. Accordingly, the NED device is enabled to display the virtual object at a brightness level that makes the virtual object appear to exist naturally within the real-world environment while simultaneously blocking out light from the real-world view, reducing NED power consumption and/or preventing the rendered image of the virtual object from appearing as a “ghostly image.”

As used herein, a “ghostly image” refers generally to a CG image through which one or more portions of a real-world view remain perceptible to a user to an unacceptable degree. For example, consider an example where a user is looking at a woodgrain pattern of an actual table through a NED device, and the NED device is also displaying a rendered image of a virtual soda can. In this situation, the virtual soda can may be considered a ghostly image in the event that the woodgrain pattern of the actual table remains perceptible to the user through a center region of the rendered image of the virtual soda can. With the dimming mask feature, the wood grain would not be visible and the virtual soda can would appear more natural and solid. In some instances, it may be desirable to form a drop shadow for the virtual soda can, where some wood grain is still visible through a darkened shadow shape of the virtual can. The opacity level of each dimming mask zone may be set to provide the degree of transparency desired to modulate real-world visibility. Based on the discussion herein of the user perceived penumbras that may surround a dimming mask, it will be appreciated that in various configurations a NED device may be unable to completely eliminate the occurrence of ghosting, especially around the perimeter of a dimming mask.

In some configurations, a system (e.g. a direct-view NED device) may include a transparent display to generate CG images and a transparent dimming panel to generate one or more dimming masks. The transparent dimming panel may be substantially adjacent to the transparent display. The system may receive image data and, based thereon, cause the transparent display to generate one or more CG images to create a composite view, from the perspective of a user, that includes the CG images superimposed over the real-world view. The system may also include and/or communicate with an eye tracking sensor to monitor physical characteristics of the user's eyes (e.g. a pupil size and/or a gaze direction) to determine size parameters and location parameters corresponding to one or more dimming masks. Then, the system may cause the transparent dimming panel to generate the one or more dimming masks to block light, from a particular region of the real-world view, from reaching the user's pupil(s). For example, the system may dynamically decrease, from a base transmittance, a transmittance level of one or more regions of the transparent dimming panel to block light that is reflected off (or emitted from for that matter) the real-world objects from passing through the region(s) of the transparent dimming panel. Accordingly, the system may supplement the user's perspective of the real-world view with the CG images while controlling both an actual brightness of the CG images (e.g. increasing and/or decreasing an actual luminous intensity at which the device generates the CG images) and also a user perceived brightness of the real-world view based upon real time physical characteristics of the user's eyes (e.g. reducing an amount of light transmitted from a real-world object that passes through the region(s) of the transparent dimming panel.

In some configurations, the system may determine (solely or in conjunction with other factors) opacity parameters for the dimming mask(s) based on eye tracking data that indicates physical characteristics of the user's eyes such as, for example, a current pupil diameter. For example, as described elsewhere herein, in various implementations, the system may determine a transmittance level for a dimming mask based on a negative correlation with the pupil diameter of the user's eyes. Stated alternatively, as the user's pupil diameter increases, the system may decrease the transmittance level of the dimming mask(s) whereas, in contrast, as the user's pupil diameter decreases, the system may increase the transmittance level of the dimming mask(s).

In some configurations, the system may determine size parameters for the dimming mask(s) based on eye tracking data that indicates physical characteristics of the user's eyes such as, for example, a current pupil diameter. For example, as described elsewhere herein, in various implementations, the system may determine a diameter and/or height-and-width (or any other dimension for that matter) for a dimming mask based on a positive correlation with the pupil diameter of the user's eyes. Stated alternatively, as the user's pupil diameter increases, the system may increase the size of the dimming mask(s) whereas, in contrast, as the user's pupil diameter decreases, the system may decrease the size of the dimming mask(s).

In some configurations, the system may communicate with a light sensor to obtain luminance data associated with a brightness of one or more portions of the real-world view. Based on the luminance data, the system may determine opacity parameters indicating one or more transmittance levels for a dimming mask. For example, if the brightness level of the real-world view is relatively high (e.g. due to the user being outside on a sunny day), the opacity parameters may cause the transparent dimming panel to generate a highly or even entirely opaque dimming mask to enhance contrast with a CG image. In contrast, if the brightness level of the real-world view is relatively low (e.g. due to the user being in an unlit night-time environment), the opacity parameters may cause the transparent dimming panel to generate a dimming mask with a relatively higher transmittance level(s).

In some configurations, the system may analyze image data to determine a shape of the one or more CG images and, ultimately, to dynamically tailor a dimming mask shape to the shape of the CG images. For example, continuing with the virtual soda can scenario (i.e. where the system generates the rendered image of the soda can virtual object), the system may identify a shape of the rendered image as being generally rectangular with a rounded top and a rounded bottom. Then, the system may determine shape parameters to cause a profile of the dimming mask to at least partially match the identified shape of the rendered image of the soda can virtual object. Accordingly, in various configurations, the system may selectively block only that light from the real-world environment that would negatively impact the appearance of one or more CG images, e.g. by shining light through the CG images from the perspective of the user.

In some configurations, the system may determine incident light parameters associated with a virtual object to generate an augmentation, such as a drop-shadow augmentation, that causes the user to perceive, within a composite view, one or more regions having a reduced brightness, such as a drop-shadow that is generated with respect to the virtual object. For example, continuing with the soda can virtual object scenario, in addition to identifying the shape of a rendered image of the soda can virtual object, the system may further identify at least one of a real light source corresponding to the real-world view or an augmented light source corresponding to the AR program. Then, the system may determine a drop-shadow protrusion to protrude from a dimming mask corresponding to the rendered image of the soda can virtual object in order to generate the appearance of a drop-shadow in association with the soda can virtual object. A common way to derive the drop shadow shape is by applying an affine transform to the soda can shape. In various implementations, the system may dynamically determine a transmittance level of the drop-shadow protrusion based upon a pupil diameter of the user's eye(s).

It should be appreciated that the above-described subject matter may also be implemented as a computer-controlled apparatus (e.g. a direct view and/or indirect view NED device), a computer process, a computing system, or as an article of manufacture such as a computer-readable medium. These and various other features will be apparent from a reading of the following Detailed Description and a review of the associated drawings. Among many other benefits, the techniques herein improve efficiencies with respect to a wide range of computing resources.

For instance, human interaction with a device may be improved as the use of the techniques disclosed herein enable a user to actually perceive CG images at a natural brightness level as compared to the real-world environment as opposed to ramping CG image brightness up higher than the real-world view. In addition, the techniques described herein greatly reduce power draw on NED devices as the generation of very bright CG images draws substantially more power than the generation of a dimming mask as described herein, e.g. by darkening a portion of a Liquid Crystal Display (LCD) panel. Human interaction with a NED device may further be improved as the use of the techniques disclosed herein enable a user to simultaneously view both CG images and a portion of a real-world view without light from the real-world view negatively affecting the user perceived image quality of the CG images, e.g. due to real-world light leaking through the CG images. Other technical effects other than those mentioned herein can also be realized from implementations of the technologies disclosed herein.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicates similar or identical items.

References made to individual items of a plurality of items can use a reference number followed by a parenthetical containing a number of a sequence of numbers to refer to each individual item. References made to right-side items and left-side items can use a reference number followed by an “R” or an “L,” respectively. Generic references to the items may use the specific reference number without the sequence of numbers. For example, the items may be collectively referred to with the specific reference number preceding a corresponding parenthetical containing a sequence number.

FIG. 1 shows an example optical system in the form of ahead-mounted display device that may generate a composite view that includes both CG images and a real-world view and that generates dimming masks to enhance contrast between the CG images and the real-world view.

FIG. 2A schematically illustrates an optical system that enhances contrast between a CG image and a real-world view by generating a dimming mask to block light that is transmitted from a real-world environment from passing through a region of a transparent dimming panel.

FIGS. 2B through 2F illustrate various user perspectives to demonstrate concepts associated with enhancing contrast between a CG image and the real-world view using the optical system of FIG. 2A.

FIG. 3A is a graph illustrating the relationship between user perceived transmittance at various field angles from the user's pupil based on a variety of different sized fully opaque dimming masks.

FIG. 3B schematically illustrates user perceived transmittance levels associated with a particular dimming mask represented in the graph of FIG. 3A.

FIG. 4A is a graph illustrating the relationship between user perceived transmittance at various field angles from the user's pupil for a constant size dimming mask driven to a variety of transmittance levels.

FIG. 4B schematically illustrates user perceived transmittance levels associated with a dimming mask of a particular size and transmittance level as represented in the graph of FIG. 4A.

FIGS. 5A-5F collectively demonstrate that an optical system may determine size parameters for one or more dimming masks based on a pupil size of a user's eye.

FIGS. 6A-6F collectively demonstrate that an optical system may determine opacity parameters that indicate at least one transmittance level for one or more dimming masks based on a pupil size of a user's eye.

FIGS. 7A-7F collectively demonstrate that the optical system may determine location parameters that indicate at least one location on the transparent dimming panel to generate one or more dimming masks based on a gaze direction of a user's eye.

FIG. 8A schematically illustrates an optical system that determines incident light parameters indicating an incident light direction associated with a light source and, based thereon, generates an augmented drop shadow in association with a rendered object.

FIGS. 8B through 8E illustrate various user perspectives to demonstrate concepts associated with generating the augmented drop shadow in association with the rendered object using the optical system of FIG. 8A.

FIG. 9 is a flow diagram of a process to generate a dimming mask(s) in association with a computer-generated (CG) image that is being generated to supplement a real-world view.

FIG. 10 shows a block diagram of an example computing system that can be deployed to perform techniques described herein.

### DETAILED DESCRIPTION

The following Detailed Description describes technologies for generating dimming masks to enhance contrast between computer-generated images (“CG images”) and a real-world view. Generally described, the techniques disclosed herein enable a system to monitor eye tracking data to determine at least one physical characteristic of a user's eye (singular) and/or eyes (plural). Then, based on the determined physical characteristic(s), the system may generate a dimming mask with relation to a CG image to decrease user perceived brightness of a real-world view (i.e. brightness of the real-world view from a user's perspective). In particular, the dimming masks may be used to control an amount of light transmitted from one or more real-world objects that is permitted to enter one or both of the user's eyes. As described above, technologies for managing contrast by controlling a user perceived brightness of the real-world view provide benefits over conventional Near-Eye-Display (NED) systems that can only manage contrast through modifications of the actual brightness of the CG images. In particular, because light from the real-world view may interfere with a NED system's ability to adequately display CG images, it may be desirable to effectively reduce the brightness of the real-world view at specific regions of a composite view that correspond to CG images.

For illustrative purposes, consider a scenario where an AR program instructs a NED device to generate a composite view by superimposing a CG image over some portion of a real-world view. For example, the AR program may cause the NED device to display a user interface (UI) menu and/or to give the appearance that a soda can is resting on top of a table that actually exists in the real-world environment by generating a rendered image, of a soda can virtual object, over a portion of the real-world view at which the table is visible. In the event that the real-world environment is sufficiently bright to interfere with a user's view of the CG image, it may be desirable to reduce the user perceived brightness of the real-world environment.

Accordingly, the techniques described herein enable the NED device to render the CG image at an appropriate brightness level while achieving the desired contrast by effectively reducing the brightness of the real-world view at the specific region where the CG image is being displayed. Stated alternative for explanatory purposes, the dimming mask may be deployed to, in a sense, “turn down” the brightness of the real-world view from the perspective of the user. Accordingly, the NED device is enabled to filter (e.g., block anywhere from slightly greater than zero percent to one-hundred percent) out light from the real-world view to prevent CG object contrast from being impaired and/or the CG image from appearing as a “ghostly image.”

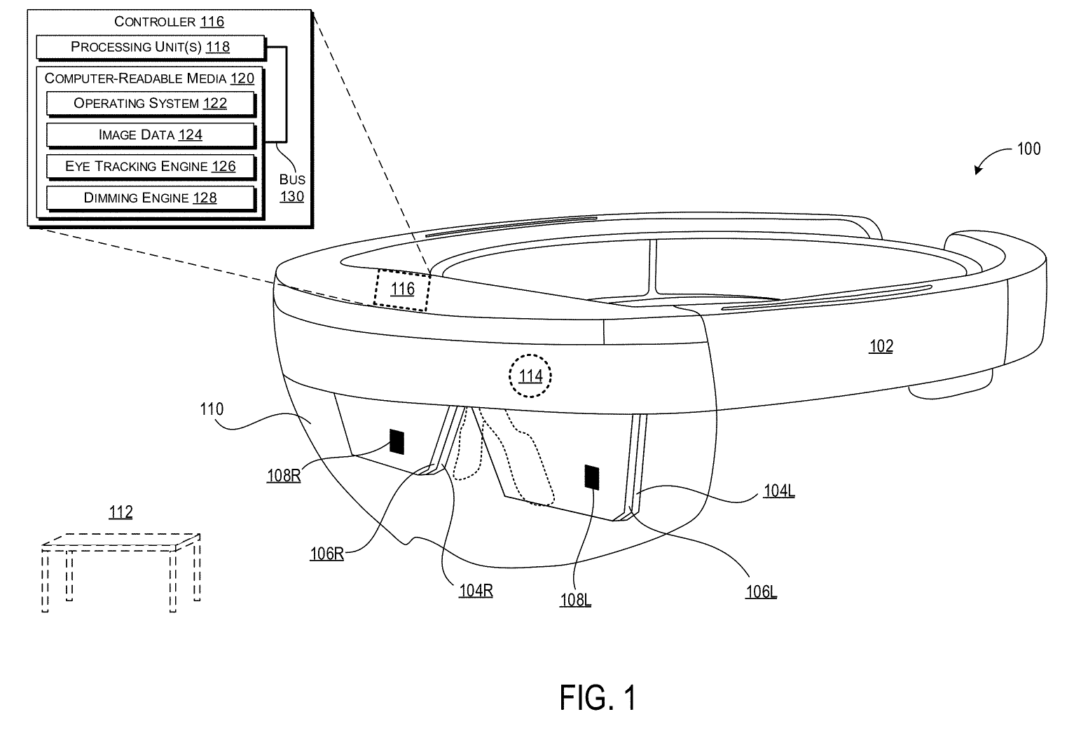

FIG. 1 shows an example optical system in the form of ahead-mounted display device 100 that may generate a composite view (e.g. from the perspective of a user that is wearing the head-mounted display device 100) that includes both one or more CG images and at least a portion of a real-world view. According to various techniques described herein, the head-mounted display device 100 may further generate dimming masks to enhance contrast between the CG images and the real-world view. The head-mounted display device 100 includes a frame 102 in the form of a band wearable around a head of a user that supports see-through display componentry positioned near the user's eyes. The head-mounted display device 100 may utilize various technologies such as, for example, augmented reality (AR) technologies to generate composite views that include CG images superimposed over a real-world view. As such, the head-mounted display device 100 is configured to generate CG images via transparent display 104. In the illustrated example, the transparent display 104 includes separate right eye and left eye transparent displays, labeled 104R and 104L, respectively. In some examples, the transparent display 104 may include a single transparent display that is viewable with both eyes and/or a single transparent display that is viewable by a single eye only.

In some embodiments, the dimming mask may be generated by the display panel as an additional function. Stated alternatively, the display panel pay itself generate both of the CG images and the dimming masks. For example, one or more lenses or other optical elements may be positioned behind (e.g. distal from the user) the dimming mask and display panel or in front of (e.g. proximate to the user) the dimming mask and display panel to deliver correct images to user.

In various embodiments, the transparent display 104 may be wholly or partially transparent. For example, the transparent display 104 may have a transmittance level of one-hundred-percent, nearly one-hundred-percent, eighty-percent, or some lesser transmittance level that remains suitable for viewing a real-world environment through. The transparent display 104 can be in any suitable form such as, for example, a waveguide, prism or multi-prism assembly configured to receive a generated CG image and direct the image towards a user's eye. In various embodiments, the transparent display 104 may be configured to use one or more light sources within the device to project the CG images toward the user's eye(s) and, more particularly, toward the user's pupil(s). The transparent display 104 may include within the device any suitable light source for generating images such as, for example, an LED projection engine.

As illustrated, the head-mounted display device 100 further includes a transparent dimming panel 106 that is positioned adjacent to a side of the transparent display 104 that is situated away from the user's pupils when the head-mounted display device 100 is properly worn. In the illustrated example, the transparent dimming panel 106 includes separate right eye and left eye transparent dimming panels, labeled 106R and 106L respectively. As illustrated, the transparent dimming panel 106 is shown to be generating dimming masks 108 having a transmittance level that is at least partially decreased from a base transmittance of the transparent dimming panel. Stated alternatively, the two regions at which the dimming masks 108R (corresponding to the user's right eye) and 108L (corresponding to the user's left eye) are being generated are more opaque (e.g. absorb more light) than the remaining regions of the transparent dimming panel 106. Accordingly, in some implementations, the head-mounted display device 100 may generate the dimming masks 108 directly behind one or more CG images that are generated by the transparent display 104 to prevent light that is reflected from one or more real-world objects from passing through the transparent display 104 at the particular location at which the CG images are being generated.

In some examples, the transparent dimming panel 106 may include a single transparent dimming panel 106 that is viewable with both eyes and/or a single transparent dimming panel 106 that is viewable by a single eye only. In some examples, the periphery of the transparent dimming panel 106 may be larger than the transparent display 104. It may extend downward and/or may extend around toward the ears, e.g. the peripheral edge. Accordingly, although the techniques of the present disclosure are described mainly with reference to implementations in which CG images and dimming masks 108 are generated in front of each of a user's two eyes, implementations in which one or more images and one or more dimming masks are generated in front of only one of the user's eyes are within the scope of the present disclosure and appended claims and are contemplated. Therefore, it can be appreciated that the techniques described herein may be deployed within a single-eye Near Eye Display (NED) system (e.g. GOOGLE GLASS) and/or a dual-eye NED system (e.g. MICROSOFT HOLOLENS).

In some embodiments, the head-mounted display device 100 may further include an additional see-through optical component 110, shown in FIG. 1 in the form of a transparent veil 110 positioned between the real-world environment 112 (which makes up no part of the claimed invention) and each of the transparent display device 104 and the transparent dimming panel 106. It can be appreciated that the transparent veil 110 may be included in the head-mounted display device 100 for purely aesthetic and/or protective purposes.

The head-mounted display device 100 may further include an eye tracking sensor 114 that is configured to generate eye tracking data associated with one or more physical characteristics of the user's eyes. Exemplary physical characteristics include, but are not limited to, pupil size, a rate of change of pupil size, gaze direction, and/or a rate of change to a gaze direction. The eye tracking sensor 114 can be in any suitable form such as, for example, a non-contact sensor configured to use optical-based tracking (e.g. video camera based and/or some other specially designed optical-sensor-based eye tracking technique) to monitor the one or more physical characteristics of the user's eyes. The head-mounted display device 100 may further include various other components, for example speakers, microphones, accelerometers, gyroscopes, magnetometers, temperature sensors, touch sensors, biometric sensors, other image sensors, energy-storage components (e.g. battery), a communication facility, a GPS receiver, etc.

In the illustrated example, a controller 116 is operatively coupled to each of the transparent display 104, the transparent dimming panel 106, and the eye tracking sensor 114. The controller 116 may further be operatively coupled to other componentry of the head-mounted display device 100. The controller 116 includes one or more logic devices and one or more computer memory devices storing instructions executable by the logic device(s) to deploy functionalities described herein with relation to the head-mounted display device 100. The controller 116 can comprise one or more processing units 118, one or more computer-readable media 120 for storing an operating system 122 and data such as, for example, image data 124. The image data 124 may define one or more CG images and may further indicate one or more locations on the transparent display 104 to generate these CG images. The computer-readable media 120 may further include an eye tracking engine 126 configured to receive the eye tracking data from the eye tracking sensor 114 and, based thereon, determine one or more physical characteristics of the user's eyes. The computer-readable media 120 may further include a dimming engine 128 configured to determine one or more dimming parameters associated with the generation of the dimming masks 108. As discussed in more detail herein, the dimming parameters may be determined based on the image data 124 and/or one or more of the physical characteristics of the user's eyes. For example, the dimming parameters may be determined based on a pupil size of the user's eyes that is determinable by the eye tracking data as well as a location that a CG image is generated on the transparent display 104 that is determinable via the image data 124. The components of head-mounted display device 100 are operatively connected, for example, via a bus 130, which can include one or more of a system bus, a data bus, an address bus, a PCI bus, a Mini-PCI bus, and any variety of local, peripheral, and/or independent buses.

As used herein, the term “dimming parameter” may refer generally to (1) any parameter that may be used in generating a dimming mask 108 that affects (1) contrast between a CG image and a real-world view; and/or (2) an amount of ambient light transmitted from (e.g. generated by and/or reflected off) the real-world environment that reaches the user's eyes. Exemplary dimming parameters include, but are not limited to, size parameters that may at least partially control a size of one or more dimming masks 108, opacity parameters that may at least partially control a transmittance level of one or more dimming masks, location parameters that may at least partially control a location of one or more dimming masks 108 on the transparent dimming panel(s) 106, and/or shape parameters that may at least partially control a shape of one or more dimming masks 108 generated by the transparent dimming panel 106.

The processing unit(s) 118, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

As used herein, computer-readable media, such as computer-readable media 120, can store instructions executable by the processing unit(s). Computer-readable media can also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media can include computer storage media and/or communication media. Computer storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, rotating media, optical cards or other optical storage media, magnetic storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media can embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

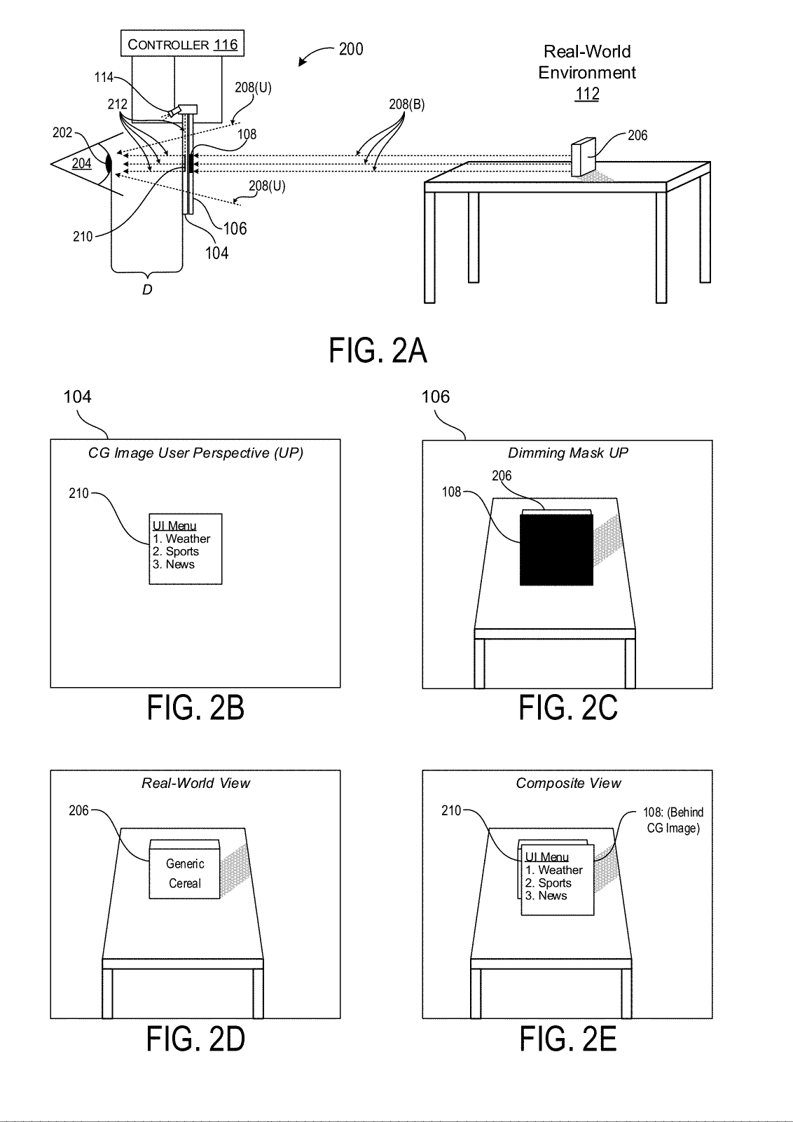

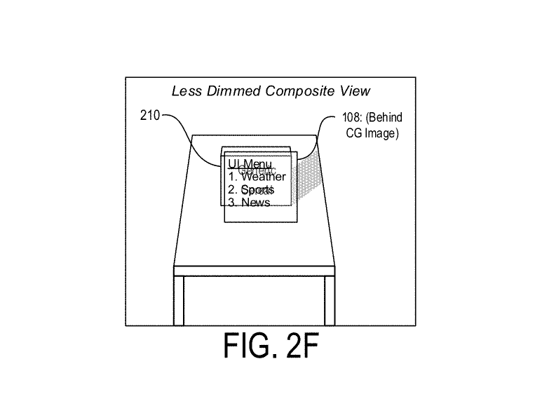

Turning now to FIG. 2A, an optical system 200 is schematically illustrated as blocking at least some ambient light from a real-world environment 112 from passing through at least a portion of the transparent display 104 and, ultimately, from reaching a pupil 202 of a user's eye 204. For example, ambient light may strike a real-world object 206 and, ultimately, may be reflected toward the pupil 202 as incoming light 208. As illustrated, the transparent dimming panel 106 may generate dimming masks 108 to block at least a portion of the incoming light 208 from reaching the pupil 202. As illustrated, the incoming light 208 includes both a blocked portion 208(B) and an unblocked portion 208(U). The blocked portion 208(B) of the incoming light corresponds to a portion of the incoming light that strikes and is blocked by the dimming masks 108 whereas the unblocked portion 208(U) of the incoming light corresponds to a different portion of the incoming light that passes through the transparent display 104 and/or the transparent dimming panel 106 and ultimately reaches the pupil 202. For example, in an implementation where the transparent dimming panel 106 corresponds to a transparent LCD display, the transparent dimming panel 106 may selectively darken (i.e. reduce a transmittance level of) one or more pixels of the transparent dimming panel 106 to block at least some of the incoming light 208 from passing through the transparent dimming panel 106 and, ultimately, the transparent display 104 toward the pupil 202.

In the illustrated implementation, the dimming masks 108 are aligned with a CG image 210 that is being generated by the transparent display 104 to cause image light 212 to propagate toward the pupil 202. In the illustrated scenario, the image light 212 is shown as originating within the optical system 200 and propagating through at least a portion of the transparent display 104 before exiting the transparent display 104 toward the pupil 202. Accordingly, in some embodiments the optical system 200 may be configured to actively generate and project the image light 212 toward the user's pupil 202. In some embodiments, however, the dimming masks 108 are driven to a transmittance level that is not fully opaque so that at least some of the incoming light 208 is allowed to pass through the dimming masks 108. For example, it is within scope of the present disclosure to deploy an at least partially transparent LCD panel to generate a CG images that are not illuminated by the system 100 but rather rely on light from the real-world environment to shine through the image to make it become visible. For example, the real-world environment may reflect (which as used herein is defined to also include emitting) through the LCD panel to act as a backlight.

In some embodiments, the transparent display 104 and/or the transparent dimming panel 106 of the optical system 200 may be positioned at a distance D from the pupil that is between 10 mm and 75 mm. In some embodiments, the transparent display 104 and/or the transparent dimming panel 106 of the optical system 200 may be positioned at a distance D from the pupil that is between 20 mm and 60 mm. In some embodiments, the transparent display 104 and/or the transparent dimming panel 106 of the optical system 200 may be positioned at a distance D from the pupil that is between 10 mm and 100 mm. In some embodiments, the transparent display 104 and/or the transparent dimming panel 106 of the optical system 200 may be positioned at a distance D from the pupil that is between 25 mm and 50 mm. In some embodiments, the transparent display 104 and/or the transparent dimming panel 106 may be positioned at a distance D from the pupil that is less than 10 mm or greater than 75 mm.

FIGS. 2B through 2F show various user perspectives to demonstrate concepts associated with using the system 200 to enhance contrast between the CG image 210 and a real-world view using the dimming masks 108.

Turning now to FIG. 2B, a CG image user perspective (UP) is illustrated to demonstrate how the CG image 210 would appear to the user of the optical system 200 in the absence of any incoming ambient light 208, i.e. both 208(B) and 208(U), from the real-world environment 112. In particular, the user of the optical system 200 would see nothing other than the CG image 210 that is generated by the transparent display 104. Although the CG image 210 is depicted as a user interface (UI) menu for purposes of the present discussion, it can be appreciated that the CG image 210 may be a rendered image that corresponds to a multidimensional model or any other type of CG image.

Turning now to FIG. 2C, a dimming mask UP is illustrated to demonstrate how the dimming masks 108 that are generated by the transparent dimming panel 106 would appear to the user of the optical system 200 in the absence of any image light 212 generated by the transparent display 104. In particular, the user of the optical system 200 would see a dark region corresponding to the dimming masks 108 and a portion of the real-world environment 112 that is not blocked by the dimming masks 108. For example, the user is able to see a top portion of the real-world object 206 (which is shown as a cereal box in FIGS. 2A-2F) as well as a portion of a real-world table that the real-world object 206 is resting upon. It can be appreciated that the portion of the real-world environment 112 that is visible to the user of the optical system 200 corresponds to the unblocked portion 208(U) of the incoming ambient light whereas the portion of the real-world environment that is not visible to the user of the optical system 200 corresponds to the blocked portion 208(B) of the incoming light.

Turning now to FIG. 2D, a real-world view is illustrated to demonstrate how the real-world environment 112 would appear to the user of the optical system 200 in the absence of any image light 212 generated by the transparent display 104 and further in the absence of any dimming masks 108 generated by the transparent dimming panel 106. For example, as illustrated, the real-world environment 112 includes a real-world object 206 that is resting upon a table that physically exists within the real-world environment 112. Accordingly, the real-world view depicted in FIG. 2D illustrates how the user of the optical system 200 would perceive the real-world environment 112 through both of the transparent display 104 and the transparent dimming panel 106.

Turning now to FIG. 2E, a composite view is illustrated to demonstrate how the user of the optical system 200 would simultaneously perceive both the unblocked portion 208(U) of the incoming light in addition to the CG image light 212. In particular, the user would perceive the CG image 210 as being superimposed with at least a portion of the real-world view. In the illustrated scenario, the user would perceive the UI menu superimposed over a portion of the real-world view that corresponds to the real-world object 206. The composite view enables the user of the optical system 200 to read information and/or select (e.g. via verbal command) one or more user interface elements associated with the CG image 210 while still being able to perceive at least a portion of the real-world view. It can be appreciated that at least some of the incoming ambient light 208 that enabled the user to visibly perceive at least a portion of the generic cereal box in FIG. 2D is being blocked by the dimming masks 108 (which is physically located behind the CG image 210 from the perspective of the user) to enhance contrast between the real-world view, and more specifically the real-world object 206, and the CG image 210.

To illustrate the enhanced contrast of FIG. 2E, FIG. 2F illustrates a less dimmed composite view as compared to the composite view of FIG. 2E. In particular, FIGS. 2E and 2F are identical to one another with the one exception that in FIG. 2E the dimming masks 108 underlaid behind the CG image 210 are fully opaque whereas in FIG. 2F the dimming masks 108 underlaid behind the CG image 210 are set as 50% transparent such that at least a portion of incoming light 208 that is reflected off the real-world object 206 passes through the dimming masks 108 and negatively impacts the user's ability to clearly distinguish the CG image 210 from the real-world view. It can be appreciated that the CG image 210 depicted in FIG. 2F may be considered to be a ghosted image whereas the CG image 210 depicted in FIG. 2E may be considered to be a non-ghosted image.

Turning back now to FIG. 2A, the optical system 200 further includes the eye tracking sensor 114 which is positioned to monitor one or more physical characteristics of the user's eye 204 such as, for example, a pupil diameter and/or gaze direction of the user's eye 204. In particular, the eye tracking sensor 114 may generate eye tracking data associated with the user's eye 204. Then, based at least in part on the eye tracking data, the optical system 200 may dynamically modify various characteristics of the dimming masks 108 according to the techniques described herein.

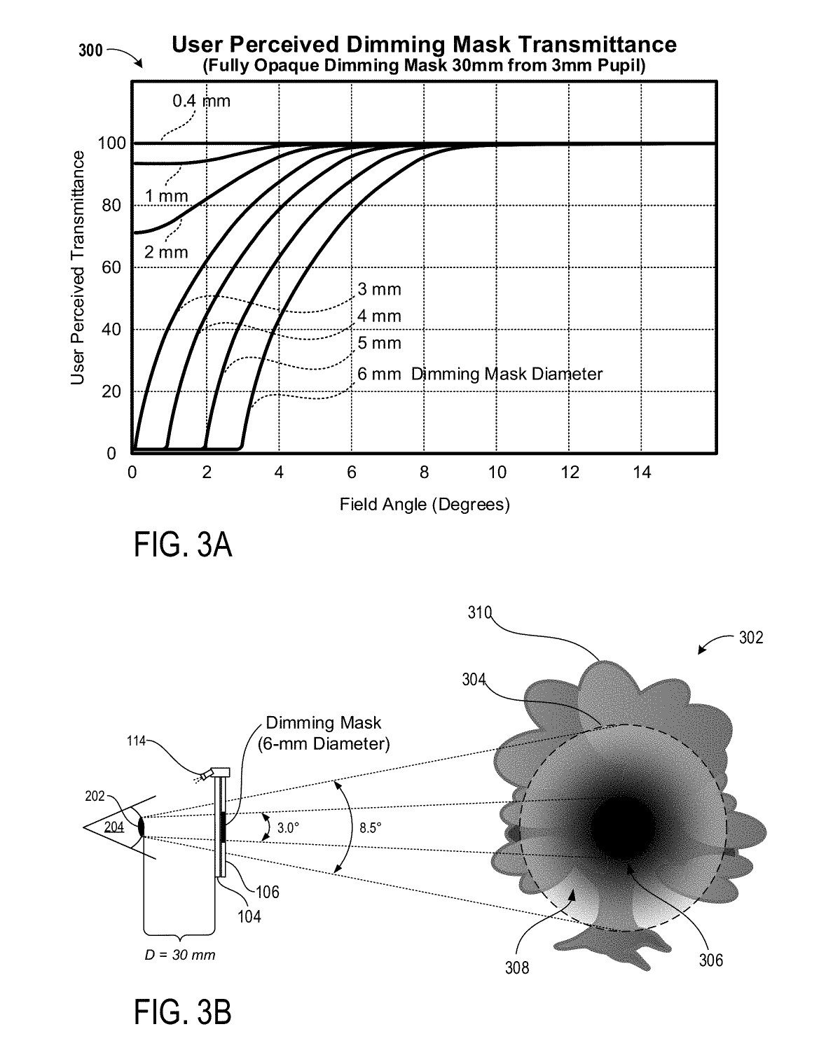

FIG. 3A is a graph 300 illustrating the relationship between user perceived transmittance at various field angles from the user's pupil for fully opaque dimming masks of a variety of sizes. In particular, the graph 300 corresponds to fully opaque dimming masks positioned at a distance of 30 mm from a user's pupil wherein the user's pupil is 3 mm in diameter and with the user's focus at 2 meters.

As illustrated, the Y-Axis corresponds to a proportion of light from a real-world environment that reaches the user's pupil at a variety of field angles corresponding to the X-Axis. For example, with reference to the line corresponding to a 6-mm dimming mask diameter, the graph 300 indicates that the user perceived transmittance is substantially zero-percent for field angles ranging from 0° to roughly 3.0°. Then, at a roughly 3.0° field angle the user perceived transmittance steeply climbs such that the user perceived transmittance from, for example, the 3.0° field angle to a 6° field angle changes from roughly zero-percent to eighty-percent. As further illustrated, the rate of change of the user perceived transmittance continually decreases until the user perceived transmittance levels out at one-hundred-percent (e.g. at roughly 8.5° for a 6-mm fully opaque dimming mask).

FIG. 3B schematically illustrates the user perceived transmittance levels associated with the 6-mm fully opaque dimming masks positioned 30 mm from a 3-mm pupil of FIG. 3A. In particular, FIG. 3B illustrates a user perceived real-world view 302 that includes an affected area 304 that is affected by the dimming masks 108. It can be appreciated that although the affected area 304 is illustrated as radial in FIG. 3B, this is due to the dimming masks being circular in this particular scenario. In various other scenarios, the affected area 304 may correspond to a substantially rectangular shape, a substantially triangular shape, a substantially elliptical shape, or any other shape associated with dimming masks.

In the particular scenario illustrated in FIG. 3B, the affected area 304 includes both a blacked-out area 306 and a penumbra area 308. Here, the blacked-out area 306 corresponds to field angles ranging from substantially 3.0° to 0° whereas the penumbra area 308 corresponds to field angles ranging from substantially 3.0° to 8.5° above which the user perceived real-world view 302 is unaffected by the dimming masks. The blacked-out area 306 corresponds to a portion of the user perceived real-world view 302 from which no incoming light is perceived by the user. The penumbra area 308 corresponds to a portion of the user perceived real-world view from which some but not all incoming light is perceived by the user.

To illustrate these concepts, the affected area is illustrated as being superimposed over a real-world object 310 which is illustrated as a tree. As illustrated, the blacked-out area 306 indicates that the user is unable to perceive any incoming light whatsoever from within the field angles of 0° to 3.0°. However, beginning at roughly 3.0° not all of the incoming light is blocked by the dimming mask and, therefore, the user begins to be able to faintly perceive the real-world object 310.

Turning back now to FIG. 3A, it can be appreciated that as the size of a particular dimming mask shrinks with respect to the size of the user's pupil, so does the corresponding affected area, e.g. in terms of field angle. For example, as illustrated by the graph 300, the line corresponding to a 5-mm dimming mask diameter indicates that the user perceived transmittance is substantially zero-percent for field angles ranging from 0° to roughly 2.0°; the line corresponding to a 4-mm dimming mask diameter indicates that the user perceived transmittance is substantially zero-percent for field angles ranging from 0° to roughly 1.0°, and so on. Furthermore, it has been observed that under certain practical circumstances for Near Eye Displays (e.g. where the dimming masks are generated at a range of 20 mm to 60 mm from the pupil), a user will not perceive a fully blacked out area such as, for example, the blacked-out area 306 shown in FIG. 3B until a size of the dimming mask is substantially equal to or greater than a size of the user's pupil. With particular reference to the line corresponding to a 3-mm dimming mask diameter placed 30-mm in front of a 3-mm pupil, the graph 300 indicates that only at dimming mask diameters at least equal to the pupil diameter does the user perceive any area having substantially zero-percent transmittance. Accordingly, the techniques described herein enable the optical system 200 to actively monitor the user's pupil diameter and dynamically modify the size of a generated dimming mask to achieve a desired user perceived transmittance.

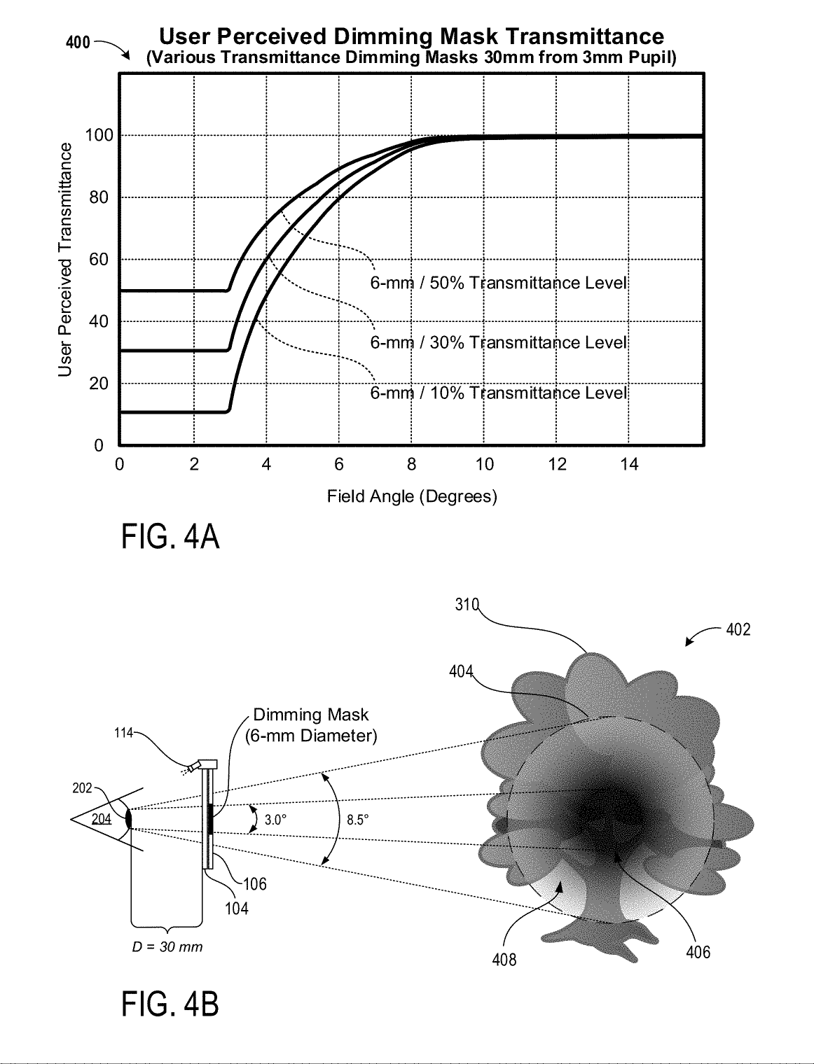

FIG. 4A is a graph 400 illustrating the relationship between the user perceived transmittance at various field angles from the user's pupil for 6-mm diameter dimming masks driven to a variety of transmittance levels. The graph 400 is similar to the graph 300 with the exception that in the graph 400 the diameter of the represented dimming masks remains constant while the transmittance level of the represented dimming masks varies.

As illustrated, the Y-Axis corresponds to a proportion of light from a real-world environment that reaches the user's pupil at a variety of field angles corresponding to the X-Axis. For example, with reference to the line corresponding to a 6-mm dimming mask diameter having fifty-percent (50%) transmissivity, the graph 300 indicates that the user perceived transmittance is fifty-percent (50%) for field angles ranging from 0° to roughly 3.0°. As in the previous graph of FIG. 3, the illustrated data corresponds to a user having a focal point that is roughly 2 meters from the pupil. Then, at a roughly 3.0° field angle the user perceived transmittance steeply climbs such that the user perceived transmittance from, for example, the 3.0° field angle to a 6° field angle changes from roughly fifty-percent (50%) to ninety-percent (90%). As further illustrated, the rate of change of the user perceived transmittance continually decreases as the user perceived transmittance levels out at one-hundred-percent (100%) (e.g. at roughly 8.5° for a 6-mm dimming mask).

FIG. 4B schematically illustrates the user perceived transmittance levels associated with the 6-mm diameter dimming masks having fifty-percent (50%) transmissivity and positioned 30 mm from a 3-mm pupil of FIG. 4A. In particular, FIG. 4B illustrates a user perceived real-world view 402 that includes an affected area 404 that is affected by the dimming mask of FIG. 4A. In the particular scenario is illustrated in FIG. 4B, the affected area 404 includes both a constant transmittance-level area 406 and a penumbra area 408. Here, the constant transmittance-level area 406 corresponds to a portion of the user perceived real-world view 402 from which the user perceives a constant transmissivity that corresponds to a transmittance level that the dimming mask is driven to. For example, in the particular scenario illustrated in FIGS. 4A-4B, the dimming masks generated by the optical system 200 are driven to a fifty-percent (50%) transmittance level which causes the user to perceive fifty-percent (50%) of the visible light reflected off the real-world objects 310 within the range of field angles that correspond to the constant transmittance level area 406. Here, the penumbra area 408 corresponds to a portion of the user perceived real-world view 402 with the amount of light perceived by the user increases from the transmittance level of the dimming mask to one-hundred (100%) transmittance at the border of the affected area 404.

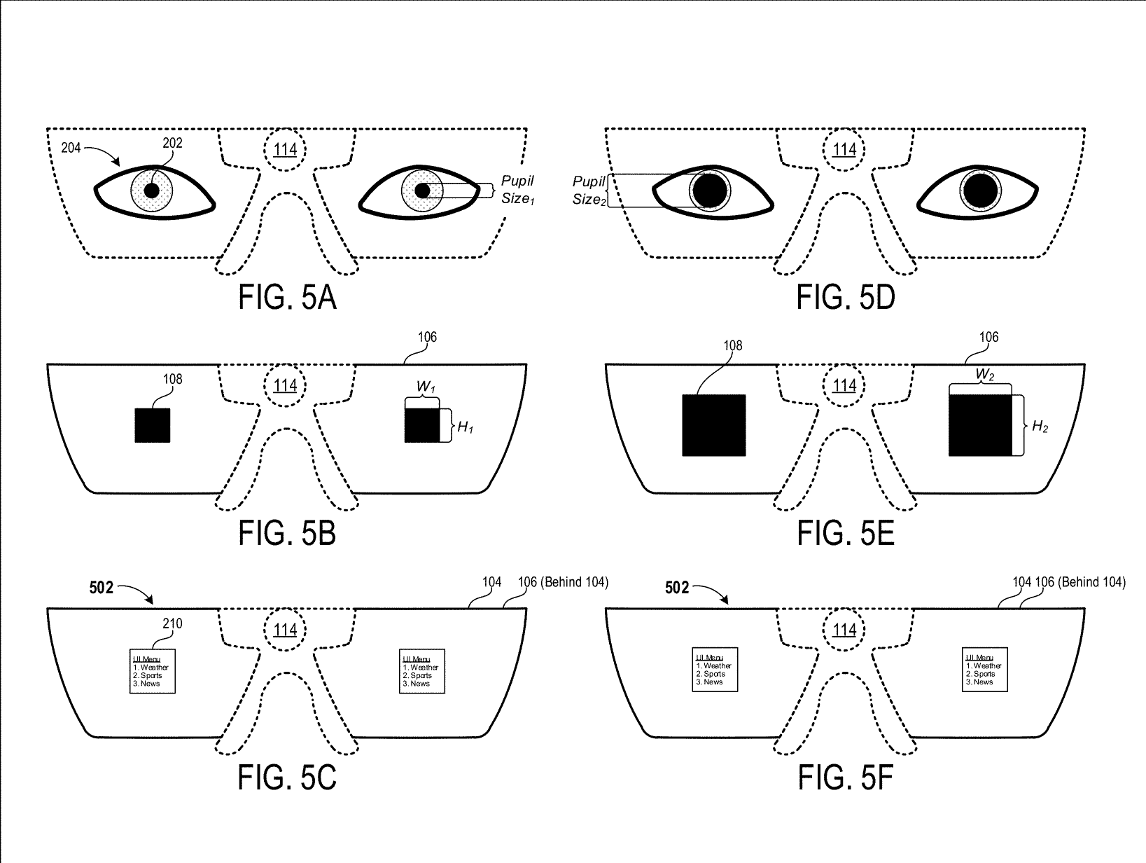

Turning now to FIGS. 5A-5F (collectively referred to as FIG. 5), a plurality of illustrations collectively demonstrate that the optical system 200 may determine size parameters for one or more dimming masks based on a pupil size of at least one eye of a user of the optical system. As illustrated, FIGS. 5A through 5C correspond to a first scenario where dimming masks are generated at a first size to achieve a user perceived composite view 502 and FIGS. 5D through 5F correspond to a second scenario where dimming masks are generated at a second size to achieve the user perceived composite view 502. It should be appreciated that as illustrated, FIG. 5C is identical to FIG. 5F.

With particular reference to FIG. 5A, a user's eyes 204 are shown as having pupils 202 of a first pupil size. The eye tracking sensor 114 may monitor the user's pupils 202 to generate eye tracking data that indicates the first pupil size. The eye tracking data may be transmitted to the controller 116 where the eye tracking engine 126 may determine substantially real-time physical characteristics corresponding to the user's eyes 204. For example, the eye tracking sensor 114 may transmit a video stream to the controller 116 and the eye tracking engine 126 may deploy one or more computer vision techniques to analyze the video stream to determine the first pupil size. Then, based on the determined physical characteristics such as, for example, the first pupil size, the dimming engine 126 may determine various dimming parameters corresponding to generation of one or more dimming masks 108. In the illustrated scenario, the dimming engine 126 has determined dimming parameters that include size parameters indicating a first width and a first height at which the transparent dimming panel is to generate the one or more dimming masks. In various implementations, the size parameters may be based at least partially on the pupil size. For example, as discussed with relation to FIG. 3A, in order to generate dimming masks having a user perceived transmittance that substantially matches a transmittance level of generated dimming masks over a particular area (e.g. measured in terms of field angle), it may be desirable to determine a size of the dimming masks based on the size of the pupil.

With particular reference to FIGS. 5A-5C, in order to blackout an area of a user perceived real-world view that corresponds precisely to the boundaries of the CG image 210 shown in FIG. 5C, the dimming engine 126 may determine first size parameters indicating a first width and a first height for generation of the dimming masks 108. However, these particular size parameters may correspond only to the first pupil size as illustrated in FIG. 5A. Therefore, in the event that the user moves to a darker ambient environment, the pupils 202 increase from the first pupil size to a second pupil size as illustrated in FIG. 5D, then the dimming engine 126 may determine new dimming parameters corresponding to generation of the one or more dimming masks 108. For example, in the illustrated scenario, the dimming engine 126 has determined new size parameters that include a second width and a second height (which are relatively bigger than the first width and first height respectively) at which the transparent dimming panel 106 is to generate the one or more dimming masks 108.

Accordingly, because the user perceived transmittance at any particular field angle within the user perceived composite view 502 is dependent upon both the current pupil size in addition to a current dimming mask size, in order for the user perceived composite view 502 as shown in FIG. 5C to remain substantially identical to the user perceived composite view 502 shown in FIG. 5F, the dimming engine 126 may determine the size parameters for the dimming masks 108 based on a positive correlation with the pupil diameter of the user's eyes. Stated alternatively, as the user's pupil diameter increases, the optical system may increase the size of the dimming mask(s) whereas, in contrast, as the user's pupil diameter decreases, the optical system may decrease the size of the dimming mask(s).

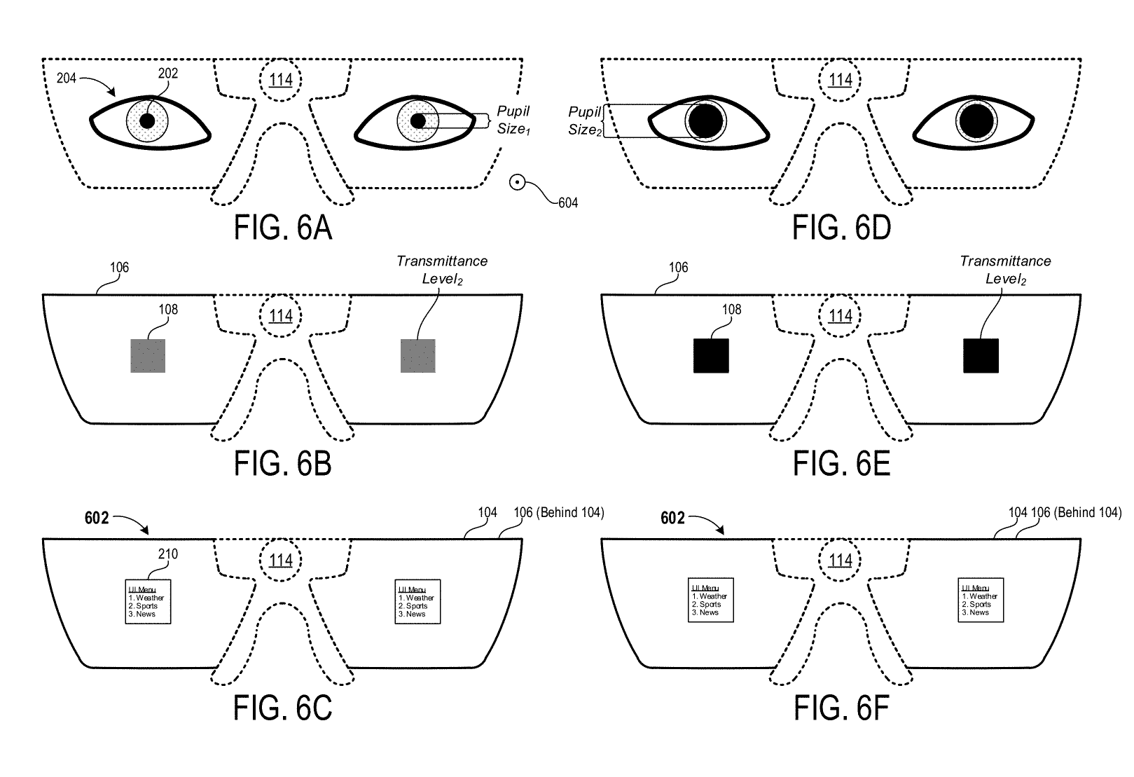

Turning now to FIGS. 6A-6F (collectively referred to as FIG. 6), a plurality of illustrations collectively demonstrate that the optical system 200 may determine opacity parameters that indicate at least one transmittance level for one or more dimming masks based on a pupil size of the user's eyes 204. As illustrated, FIGS. 6A through 6C correspond to a first scenario where dimming masks are generated at a first transmittance level to achieve the desired level of contrast between a real-world view and a CG image 210 as depicted in FIG. 6C. Furthermore, FIGS. 6D through 6F correspond to a second scenario where the dimming masks have been changed to a second transmittance level to achieve the desired level of contrast between the real-world view in the CG image 210 as depicted in FIG. 6F. As illustrated FIG. 6C is similar to FIG. 6F.

With particular reference to FIG. 6A, a user's eyes 204 are shown as having pupils 202 of a first pupil size. Accordingly, the dimming engine 128 may determine various dimming parameters corresponding to generation of dimming masks 108 based at least in part on the first pupil size. In the illustrated scenario, the dimming engine 128 has determined dimming parameters that include opacity parameters indicating a first transmittance level to drive the one or more dimming masks to, wherein the first transmittance level is based at least in part on the first pupil size. For example, because the user perceived transmittance of any particular field angle within a user perceived composite view 602 is dependent upon both the current pupil size as well as a current transmittance level of one or more portions of the dimming masks 108, it can be appreciated that under various circumstances it may be desirable to dynamically modify a transmittance level of dimming masks based on a current pupil diameter of the user's eyes in order to achieve a desired level of contrast between the real-world view in the CG image 210.

Accordingly, in the event that the pupils 202 increase from the first pupil size to a second pupil size as illustrated in FIG. 6D, then the dimming engine 128 may determine new dimming parameters corresponding to the generation of the dimming masks in order to maintain the desired level of contrast between the real-world view and the CG image 210. For example, in the illustrated scenario, the dimming engine 128 has determined new opacity parameters that indicate a second transmittance level to drive the dimming masks to in order to maintain the desired level of contrast. Stated alternatively, for the purpose of maintaining an appearance of the CG image 210 in the face of fluctuating pupil sizes, the dimming engine 126 may dynamically cause the transparent dimming panel 106 to modify a transmittance level of dimming masks. In some implementations, the dimming engine 126 may determine the transmittance levels for the dimming masks 108 based on a negative correlation with the pupil diameter of the user's eyes. Stated alternatively, as the user's pupil diameter increases the optical system may decrease the transmittance level of the dimming mask(s) whereas, in contrast, as the user's pupil diameter decreases the optical system may increase the transmittance level of the dimming masks.

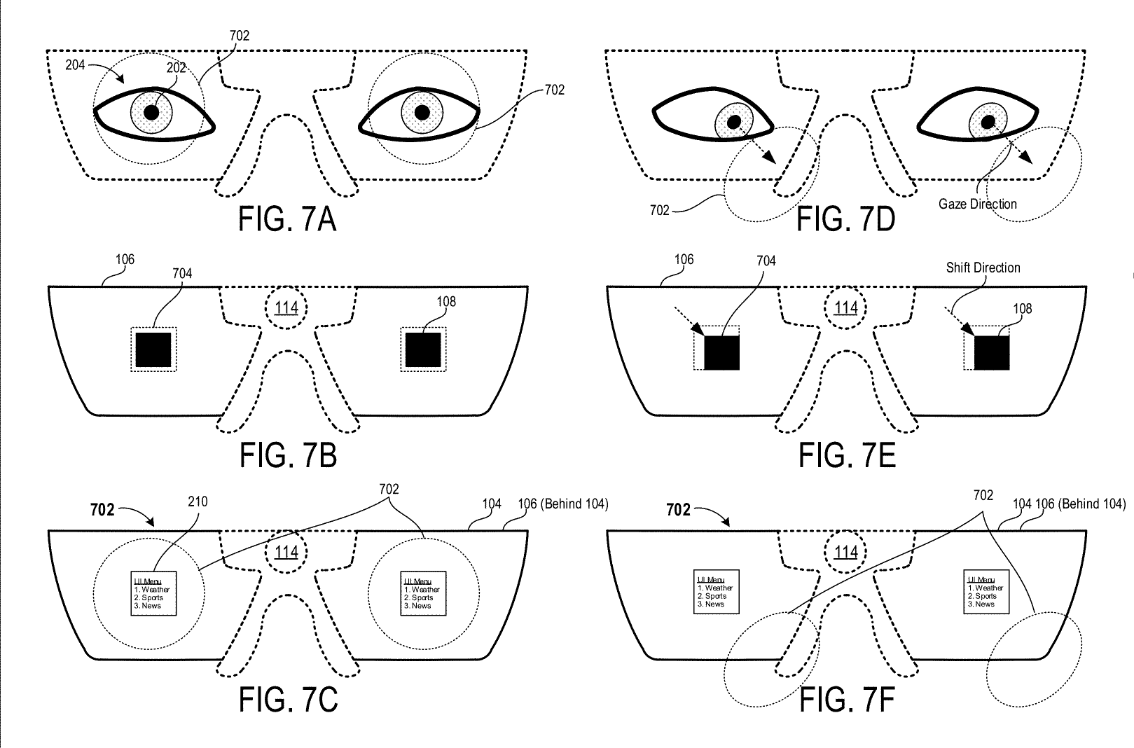

Turning now to FIGS. 7A-7F (collectively referred to as FIG. 7), a plurality of illustrations collectively demonstrate that the optical system may determine location parameters that indicate at least one location on the transparent dimming panel 106 to generate the dimming masks 108 based on a gaze direction of the user's eyes 204. As illustrated, FIGS. 6A through 6C correspond to a first scenario where dimming masks are generated at a first location based on the gaze direction being a direction substantially straight out of the page (i.e. the user's gaze direction is indicated by the out of page vector symbol 604) to achieve the desired level of contrast between a real-world view and a CG image 210 as depicted in FIG. 7C. Furthermore, FIGS. 7D through 7F correspond to a second scenario where the dimming masks have been moved to a second location based on the gaze direction changing from straight out of the page to the gaze direction indicated in FIG. 7D (user looking down and to the left). As illustrated FIG. 7C is similar to FIG. 7F.

With particular reference to FIG. 7A, a user's eyes 204 are shown as having pupils 202 that are directed straight out of at the page such that a central vision area 702 of the user's real-world view is substantially centered on the CG image 210 as illustrated in FIG. 7C. Accordingly, with particular reference to FIG. 7B the dimming masks 108 are generated by the transparent dimming panel 106 at a first location that is substantially centered within an outer profile 704 of the CG image 210. It is worth noting that the outer profile 704 of the CG image 210 is illustrated only in FIG. 7B and FIG. 7E and is located in exactly the same location in each of these figures. The purpose of illustrating the outer profile 704 in FIGS. 7B and 7E is to make the relatively subtle shift of the dimming masks 108 from the first location illustrated in FIG. 7B to the second location illustrated in FIG. 7E more apparent.

For purposes of FIG. 7, the dimming engine 128 has determined that dimming masks of a particular size and/or transmittance level, located at the first location which is substantially centered within the outer profile 704 of the CG image 210 will produce a desired level of contrast between the real-world view and the CG image 210 (as illustrated in FIG. 7C) when the user's gaze direction is substantially straightforward. However, with particular reference to FIGS. 7D and 7E, in the event that the user changes her gaze direction as illustrated such that the central vision area 702 of the user's real-world view is no longer centered on the CG image 210 but is offset downwards into the user's left, (i.e. the right side as illustrated) the dimming engine may determine that a shift to the dimming masks may be desirable to maintain enhanced contrast between the CG image 210 and the real-world view.

Accordingly, in the event that the gaze direction changes as illustrated in FIG. 7D, the dimming engine 128 may then determine new location parameters corresponding to the generation of the dimming masks 108 in order to shift the dimming masks 108 as illustrated with respect to the outer profile 702 of the CG image 210 in order to maintain the desired level of contrast. Stated alternatively, as the user's gaze direction changes, the optical system may continually re-calculate location parameters for the dimming masks 108 to cause the dimming masks 108 to at least partially track the user's gaze direction.

In some examples, multiple CG images may be presented to the user where each may have at least one corresponding dimming masks. In some examples, when multiple masks are in use and the CG image objects are sufficiently separated, it may be desirable to enable only the dimming masks for the CG objects that are in the line of sight based on the user's gaze angle. One benefit of the selective enabling of dimming masks with gaze angle includes, but is not limited to, preventing the user from being visually distracted.

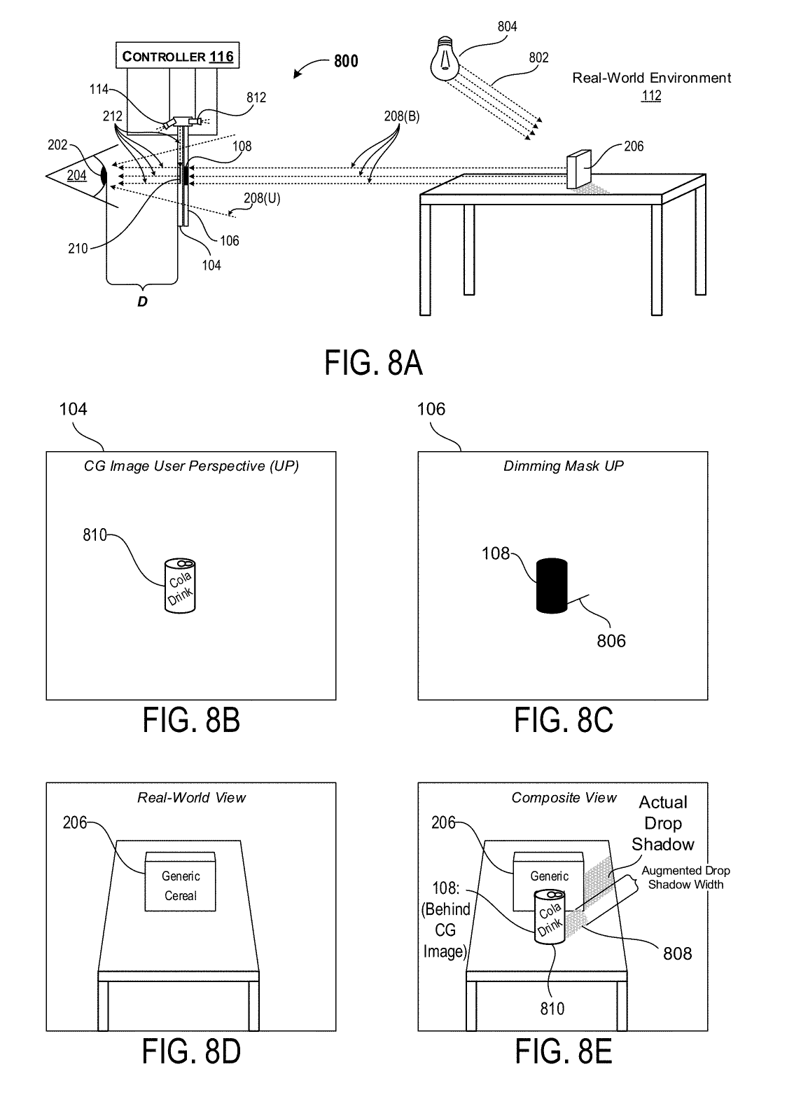

Turning now to FIGS. 8A-E, an optical system 800 is schematically illustrated as determining incident light parameters indicating an incident light direction 802 associated with at least one light source 804 and, based thereon, generating a shadow protrusion 806 (shown in FIG. 8C) to generate an augmented drop shadow 808 (shown in FIG. 8E) in association with at least one rendered object 810 (shown in FIG. 8E). The optical system 800 may include componentry for identifying at least one of a real light source corresponding to the real-world environment (e.g. as illustrated in FIG. 8A) or an augmented light source that does not exist in the real-world environment but rather is mimicked by the optical device. For example, the transparent display 104 may generate one or more bright regions that are designed to mimic a light source.

It can be appreciated that the system 800 of FIGS. 8A-8E has much in common with the system 200 of FIGS. 2A-2F. Accordingly, numerous details discussed with relation to FIGS. 2A-2F may also apply to FIG. 8A and for purposes of reducing redundancy will not be re-described with respect to FIGS. 8A-8E.

Under the illustrated circumstances in which the optical system 800 identifies a real light source corresponding to the real-world environment, the optical system 800 may deploy a light sensor 812 such as, for example, one or more forward facing cameras that are configured to identify one or more light sources that correspond to the real-world environment 112. The optical system 800 may then determine incident light parameters corresponding to the identified light source 804. Exemplary incident light parameters include, but are not limited to, an incident light direction 802, a luminous intensity of the incident light, and/or a color of the incident light.

Then, based on the incident light parameters, the system may determine a drop shadow protrusion for the purpose of generating an augmented drop shadow 808 in association with a rendered object 810. For example, in the illustrated scenario the rendered object 810 corresponds to a soda can virtual object that the optical system 800 is to give the appearance of resting on the actual table in front of the real-world object 206, e.g. the generic cereal box. As can be seen in each of FIGS. 8A and 8E, incident light 802 strikes the real-world object 206 and creates an actual drop shadow. Accordingly, it can be appreciated that generating the composite view of FIG. 8E without generating the augmented drop shadow 808 may appear unnatural, e.g. two physical objects in a similar environment would typically either both create drop-shadows or not. Accordingly, in order to generate a composite view with as natural an appearance as possible, the optical system 800 may determine both dimming masks 108 that have a shape that is determined based on a shape of the CG image 810 in addition to a shadow protrusion 806. In some implementations, the shadow protrusion 806 may extend outward from the dimming masks 108 in the form of a straight line as illustrated in FIG. 8C. Because various characteristics such as, for example, a color and/or texture of an object that a shadow is falling upon may remain at least partially perceptible despite the presence of the shadow, it should be appreciated that generating a natural looking augmented drop shadow 808 may call for a particular region to be merely slightly darkened and not wholly blacked out. Therefore, it should further be appreciated from the discussion of FIGS. 3A-3B and FIGS. 4A-4B that in some instances creating an augmented drop shadow having a particular width (as shown in FIG. 8E), may be achievable with a drop shadow protrusion of substantially lesser width (e.g. as shown in FIG. 8C) so that the penumbra area is used to mimic a shadow.

In one specific but non-limiting example, the optical system may vary dimming mask region size and opacity to create a narrower or wider shadow with penumbra. For example, referring to FIG. 3A, in one example a fully opaque dimming mask diameter of 2 mm would generate a 70% transmitting spot with approximately a five degree penumbra. Referring to FIG. 4A, in another example, using a six mm dimming mask at 70% transmittance level, would generate a 70% transmitting spot of three degrees plus a six degree penumbra. In this manner, drop shadows of various size and transmittance combinations may be formed.

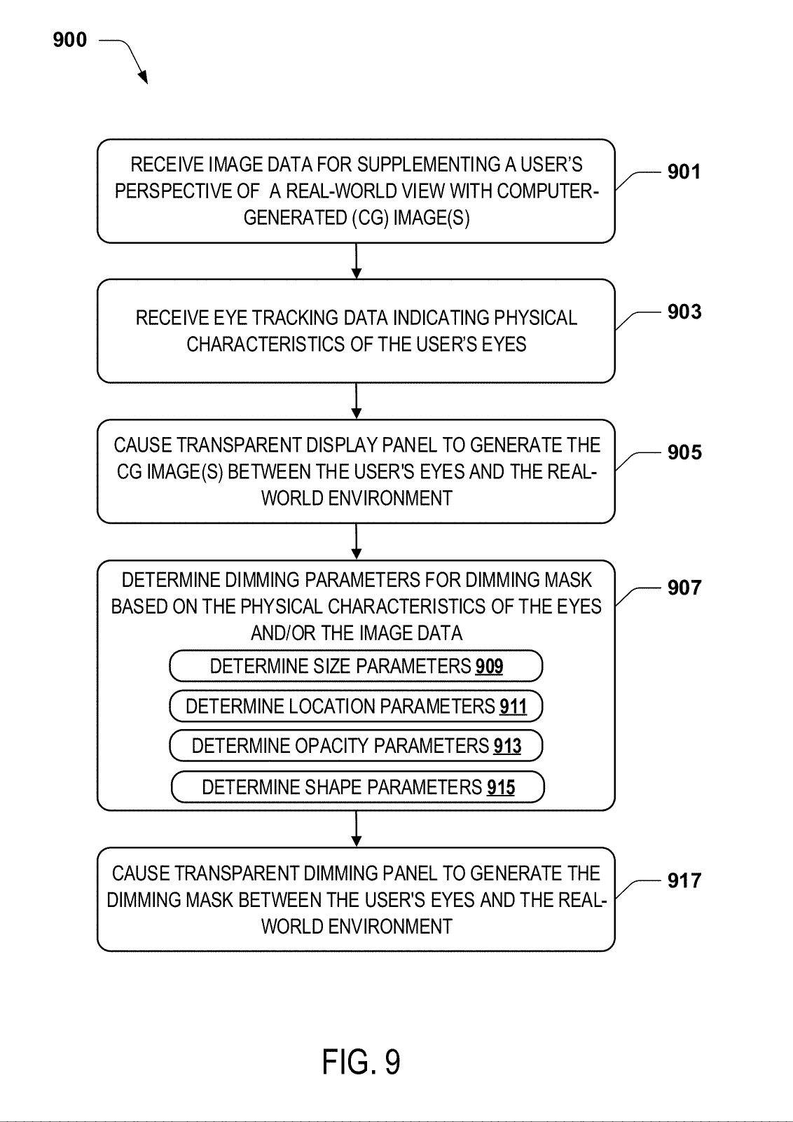

Turning now to FIG. 9, a flow diagram is illustrated of a process 900 to generate dimming masks in association with a computer-generated (CG) image that is being generated to supplement a real-world view. The process 900 is described with reference to FIGS. 1-8E. The process 900 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform or implement particular functions. The order in which operations are described is not intended to be construed as a limitation, and any number of the described blocks can be combined in any order and/or in parallel to implement the process. Other processes described throughout this disclosure shall be interpreted accordingly.

At block 901, the system may receive image data associated with supplementation of a user perspective of a real-world view with at least one CG image. The image data may define the CG image(s) in addition to parameters corresponding to generating the one or more images on the transparent display 104. For example, the image data may define the UI menu shown in FIG. 2B in addition to parameters that indicate when to display the UI menu, where to display the UI menu, whether to generate the UI menu in an at least partially transparent manner (e.g. such that the real-world view can be faintly seen through the UI menu), whether to generate the UI menu in a wholly nontransparent manner (e.g. such that no portion of the real-world view is visible through the UI menu), or any other parameter associated with the presentation of the UI menu and/or any other applicable type of CG image. In some implementations, the image data may indicate one or more locations on the transparent display 104 to generate one or more CG images. For example, with particular reference to FIG. 7C, the image data may indicate that the UI menu is to be generated at a location that is centered within the central vision area 702 of the user's real-world view, e.g. under the assumption that the user is looking straightforward as shown in FIG. 7A. The image data may further indicate whether to move a particular CG image in response to a shift in the user's eye gaze direction. For example, as shown in the cumulative illustrations of FIG. 7, under the illustrated circumstances the image data indicates that the UI menu is to remain static on the transparent display device 104 regardless of the illustrated shift in the user's gaze direction between FIG. 7A and FIG. 7D.

As another example, with particular reference to FIG. 8, the image data may indicate a special location within the real-world environment 112 to give the appearance that one or more virtual objects is residing there. For example, the image data may cause the system to give the appearance that the virtual soda can object is actually resting on the actual table shown in FIG. 8. Accordingly, the system may access three-dimensional model data associated with the virtual soda can object to calculate two-dimensional rendered images of the virtual soda can object from the perspective of the user and display the two-dimensional rendered images on the transparent display 104 with respect to the real-world environment 112. The image data may further indicate a size at which the CG image is to be generated by the transparent display device 104. For example, the system may identify a depth of field of the actual table and/or the actual cereal box from the user (e.g. by deploying a rangefinder and/or stereo vision depth calculation techniques) and calculate a size to render the two-dimensional rendered images of the virtual soda can object with respect to the user's distance from the spatial location within the real-world environment 112 that the object is to be given the appearance that it resides there.

At block 903, the system may receive eye tracking data associated with physical characteristics of the user's eyes. For example, the system may include the eye tracking sensor 114 positioned to monitor physical characteristics of the user's eyes. Exemplary such physical characteristics include, but are not limited to, a pupil diameter and/or a gaze direction of one or more of the user's eyes. Referring specifically to FIG. 1, it can be appreciated that in implementations in which the optical system is in the form of a head-mounted display device 100, the eye tracking sensor 114 may be positioned to actively monitor the physical characteristics of the user's eyes while the user is wearing the head-mounted display device 100.

At block 905, the system may cause the transparent display 104 to generate the CG image(s) between the user's eyes 204 and the real-world environment 112. For example, as illustrated in FIG. 2A, the transparent display 104 is positioned directly between the eye 204 and the real-world object 206 such that looking at the real-world object requires the user to look through each of the transparent display 104 and the transparent dimming panel 106. Accordingly, in some implementations the image data received at block 901 may indicate a location on the transparent display 104 to generate the CG image 210 wherein the location is directly between the eye 204 and the real-world object 206.

At block 907, the system may determine dimming parameters for at least one dimming mask based on at least one of the physical characteristics of the user's eyes and/or the image data. The dimming parameters may be associated with enhancing contrast between the CG image generated by the transparent display 104 and the real-world view. In particular, as described in more detail elsewhere herein, the dimming parameters may define at least one dimming mask that can be generated to effectively reduce brightness of at least a portion of the real-world environment 112 from the perspective of the user, i.e. in the real-world view. Stated alternatively, the dimming masks may reduce the brightness of one or more regions of the real-world view.

At block 909, determining dimming parameters for the at least one dimming mask may include determining size parameters. In some implementations, the size parameters may cause the system to generate a dimming mask that spans across substantially all of a functional area of the transparent dimming panel 106. For example, the transparent dimming panel 106 may include a functional area that has transmittance level control capabilities, i.e. a functional capability of controllably changing a transmittance level. In one exemplary embodiment, the dimming panel 106 may have a functional area having base transmittance that is highly transparent (e.g. eighty-percent (80%) transmittance or higher) and the ability of controllably decreasing the transmittance level of one or more regions of the functional area. Accordingly, under various circumstances, the size parameters may cause the system to generate a dimming mask over the entire functional area by controllably decreasing the transmittance level of the entire functional area.

In some implementations, the system may determine at least one size parameter based at least in part on the pupil diameter of the user's eyes. For example, as described with relation to FIG. 5, the system may controllably determine one or more dimensions of the dimming masks 108 based on a current pupil size. Furthermore, the system may dynamically change the one or more dimensions of the dimming masks 108 based on substantially real time physical characteristics of the user's eyes. For example, upon the pupil diameter of the user's eyes increasing as shown between FIGS. 5A and 5D, the system may quickly respond by increasing the size of the dimming masks as shown between FIGS. 5B and 5E. In some implementations, at least one size parameter may cause at least one of dimming masks 108 to cover an area of the transparent dimming panel 106 that is at least as big as an area of the pupil 202. For example, suppose that the diameter of the pupil 202 is three millimeters such that an area of the pupil 202 is roughly seven square-millimeters. Under these circumstances, the system may determine the at least one size parameter to cause an area of the dimming masks 108 to cover at least seven square-millimeters of the transparent dimming panel 106. In some implementations, the at least one size parameter may cause the at least one dimming masks 108 to cover an area of the transparent dimming panel 106 that is between 1 to 3 times an area of the pupil. For example, continuing with the assumption that the area of the pupil 202 is roughly seven square-millimeters, under certain circumstances the at least one size parameter may cause the dimming masks to cover an area that is between seven to twenty-one square-millimeters.

In some implementations, the system may determine at least one size parameter based at least in part on the image data. For example, under circumstances where the system is to generate a dimming mask 108 behind an entire area of a CG image that is generated by the transparent display 104, the actual size at which the transparent dimming panel 106 should generate the dimming masks 108 to achieve this goal will vary based on the size of the CG image 210 as it is generated by the transparent display 104 and perceived at the nominal focus distance.

In some implementations, the system may determine at least one size parameter based at least in part on a gaze direction of the user's eyes. For example, consider a scenario where the system is to generate dimming masks that cover substantially all of a particular quadrant of the user's vision with the exception of a portion of the quadrant that falls within a central vision area 702 as illustrated in FIGS. 7B and 7E. It can be appreciated with reference to FIGS. 7A and 7D that as the user's gaze direction shifts, the total area of any particular quadrant of the user's vision that falls outside the central vision area 702 while passing through the transparent dimming panel will vary. Accordingly, in some implementations a shifting of the user's gaze direction may trigger recalculation of one or more size parameters.

At block 911, determining dimming parameters for the at least one dimming masks 108 may include determining location parameters. In some implementations, the system may determine at least one location parameter based at least in part on the image data. For example, in a scenario where the system is to superimpose a dimming mask with a particular CG image, it can be appreciated that the appropriate location on the transparent dimming panel 106 to generate the dimming masks 108 will be at least partially dependent on a corresponding location in the visual field at which a corresponding CG image 210 is generated and the interpupil spacing of the user which may range from 51 mm-73 mm. In some cases, however, the interpupil spacing may be less than 51 mm or greater than 73 mm. It can be appreciated that in various implementations, the dimming mask position should be in good alignment with the viewers pupil and the CG object. In some implementations, the system may determine at least one location parameter based at least in part on the gaze direction of the user's eyes. For example, with particular reference to FIG. 7, the system may be configured to identify a shift in the user's gaze direction based on the eye tracking data and, ultimately, to maintain a desired level of contrast between a CG image 210 and a real-world environment by relocating the at least one dimming masks 108 in response to the shift in the user's gaze direction.

At block 913, determining dimming parameters for the at least one dimming masks may include determining opacity parameters. The opacity parameters may indicate at least one transmittance level that is less than a base transmittance level of the transparent dimming panel 106. For example, under a circumstance where the base transmittance level of the transparent dimming panel 106 is ninety-percent (90%), the opacity parameters may cause the system to generate the at least one dimming masks 108 by driving one or more regions of the transparent dimming panel 106 to a relatively lesser transmittance level of, for example, twenty-percent (20%), ten-percent (10%), substantially zero-percent (0%), or any other desirable transmittance level.

In some implementations, the system may determine at least one opacity parameter based at least in part on a pupil size of the user's eyes. For example, with particular reference to FIG. 6, the system may be configured to identify a current size of the user's pupil based on the eye tracking data and, ultimately, to determine a desired transmittance level for the at least one dimming masks 108 based upon the pupil size. Under the particular circumstances described with relation to FIG. 6, determining the at least one opacity parameter may include determining a transmittance level that is based upon an inverse relationship to a pupil diameter. In some implementations, determining the at least one opacity parameter may include determining a transmittance level that is based on a positive relationship to pupil diameter such that as the pupil diameter increases so does the transmittance level of the at least one dimming masks 108.

In some implementations, the system may determine at least one opacity parameter based at least in part on luminance data that indicates a luminous intensity corresponding to one or more regions of the real-world view. For example, the system may deploy a light sensor 812 to determine a brightness (e.g. a luminous intensity) of the real-world view. Then, based upon the brightness of the real-world view, the system may determine how low to set the transmittance level of the at least one dimming region. Stated alternatively, the amount to which the system effectively turns down the brightness of the real-world view may be at least partially dependent on the brightness of the real-world view to begin with.

In some implementations, the system may determine at least one opacity parameter based at least in part on the gaze direction of the user's eyes. For example, under certain circumstances it may be desirable to dynamically modify a transmittance level of a particular dimming mask based upon where that dimming mask falls within the user's vision, e.g. in terms of field angle. With particular reference to FIG. 7, it can be appreciated that the dimming masks 108 falls within a different region of the user's vision in FIG. 7C than it does in FIG. 7F. Accordingly, under certain circumstances in addition to and/or in place of shifting the dimming masks on the transparent dimming panel 106, the system may be configured to dynamically modify the transmittance level of the dimming masks 108 based upon the user's change in gaze direction.

In some implementations, the at least one opacity parameter may indicate a predetermined transmittance level for one or more dimming masks 108. For example, an opacity parameter may cause the transparent dimming panel 106 to generate a dimming mask at a particular transmittance level (e.g. fully opaque) regardless of the image data and/or various physical characteristics of the user's eyes.

At block 915, determining dimming parameters for the at least one dimming mask 108 may include determining shape parameters. The shape parameters may define a shape for the at least one dimming masks 108 by, for example, defining an outer profile of the at least one dimming mask and/or defining parameters associated with sizing, locating and/or orienting one or more predetermined shapes. Exemplary predetermined shapes include, but are not limited to, a circle shape that can be defined by a radius and a reference location, a square that can be defined by a side length and a reference location/angular orientation, a triangle that can be defined by one or more side lengths and a reference location/angular orientation, and/or a rectangle that can be defined by at least two side lengths and a reference location/angular orientation.

In some implementations, the shape parameters may be based at least partially on the image data. Determining the shape parameters may include analyzing the image data to determine a shape of at least one CG image 210. For example, the system may determine an outer profile for the UI menu of FIG. 2 and/or an outer profile of the rendered image of the virtual soda can object of FIG. 8. In some implementations, the shape parameters may cause a profile of the at least one dimming masks 108 to at least partially match the shape of a CG image. For example, with particular reference to FIG. 8, the shape of the dimming masks as shown in FIG. 8C substantially match the shape of the rendered image of the virtual soda can object shown in FIG. 8B. In some implementations, the shape parameters may cause a user perceived penumbra (as discussed with relation to FIGS. 3 and 4) to be at least partially positioned over a profile of a CG image. For example, the shape parameters may cause a constant transmittance level area 406 at FIG. 4B to lie entirely within an interior boundary of a profile of the CG image and an outer boundary of an affected area 404 to fall at least partially outside the profile of the CG image 210.

At block 917, the system may cause a transparent dimming panel 106 to generate the dimming masks 108 between the user's eyes and the real-world environment. For example, the system may utilize the dimming parameters determined at block 907 to cause the transparent dimming panel 106 to controllably alter a transmittance level of one or more regions to enhance contrast between the real-world view and the CG image 210 generated at block 905. Upon being generated, the at least one dimming masks 108 may block at least some light that is transmitted by (e.g. either generated by or reflected off) a real-world object from passing through the transparent display and reaching a pupil of the user's eye.

While described herein in the context of near-eye display systems, the example optical systems and methods disclosed herein may be used in any suitable optical system, such as a rifle scope, telescope, spotting scope, binoculars, and heads-up display.

In some embodiments, the methods and processes described herein may be tied to a computing system of one or more computing devices. In particular, such methods and processes may be implemented as a computer-application program or service, an application-programming interface (API), a library, and/or other computer-program product.

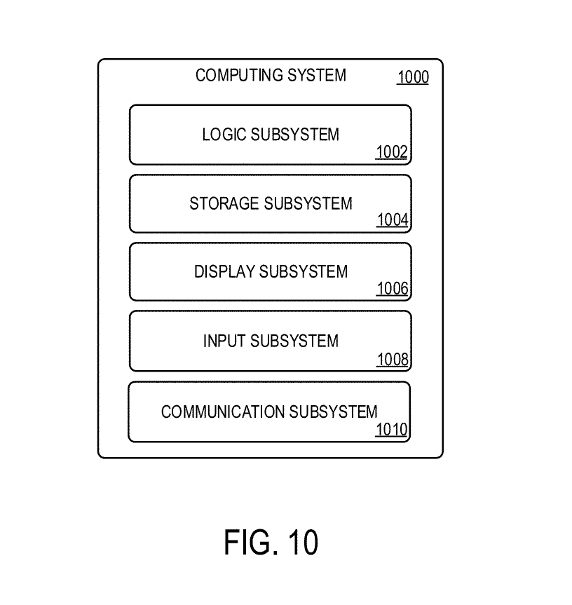

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic subsystem 1002 and a storage subsystem 1004. Computing system 1000 may optionally include a display subsystem 1006, input subsystem 1008, communication subsystem 1010, and/or other components not shown in FIG. 6.

Logic subsystem 1002 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 1002 may include one or more processors configured to execute software instructions. Additionally or alternatively, logic subsystem 1002 may include one or more hardware or firmware logic machines configured to execute hardware or firmware instructions. Processors of logic subsystem 1002 may be single-core or multi-core, and the instructions executed thereon may be configured for sequential, parallel, and/or distributed processing. Individual components of logic subsystem 1002 optionally may be distributed among two or more separate devices, which may be remotely located and/or configured for coordinated processing. Aspects of logic subsystem 1002 may be virtualized and executed by remotely accessible, networked computing devices configured in a cloud-computing configuration.

Storage subsystem 1004 includes one or more physical devices configured to hold instructions executable by logic subsystem 1002 to implement the methods and processes described herein. When such methods and processes are implemented, the state of storage subsystem 1004 may be transformed—e.g., to hold different data.

Storage subsystem 1004 may include removable and/or built-in devices. Storage subsystem 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1004 may include volatile, nonvolatile, dynamic, static, read/write, read-only, random-access, sequential-access, location-addressable, file-addressable, and/or content-addressable devices.

It will be appreciated that storage subsystem 1004 includes one or more physical devices. However, aspects of the instructions described herein alternatively may be propagated by a communication medium (e.g., an electromagnetic signal, an optical signal, etc.) as opposed to being stored on a storage medium.

Aspects of logic subsystem 1002 and storage subsystem 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1006 may be used to present a visual representation of data held by storage subsystem 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. Such display devices may be combined with logic subsystem 1002 and/or storage subsystem 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-board or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 600 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

### Example Clauses

The disclosure presented herein may be considered in view of the following clauses.

Example Clause A, a computer-implemented method, comprising: receiving image data indicating at least one location on a transparent display to generate at least one computer generated image (CGI); obtaining, from at least one eye tracking sensor, eye tracking data associated with at least one eye that is positioned for viewing a real-world view, the eye tracking data indicating at least a pupil diameter of the at least one eye; causing the transparent display to generate the at least one CGI at the at least one location, wherein the at least one location is positioned on the transparent display between the at least one eye and a real-world object that is visible within the real-world view; determining, based at least in part on the pupil diameter, at least one size parameter associated with at least one dimming mask for enhancing contrast between the at least CGI and the real-world view; determining, based at least in part on the at least one location of the image data, at least one location parameter associated with the at least one dimming mask; and causing, based on the at least one size parameter and the at least one location parameter, a transparent dimming panel to generate the at least one dimming mask with respect to the at least one location on the transparent display, wherein the at least one dimming mask blocks at least some light that is transmitted from the real-world object from passing through the at least one location on the transparent display toward at least one pupil of the at least one eye.

Example Clause B, the computer-implemented method of Example Clause A, further comprising: determining, based at least in part on the image data, opacity parameters that indicate at least one transmittance level that is less than a base transmittance of the transparent dimming panel; and causing a plurality of pixels of the transparent dimming panel to be driven to the at least one transmittance level.

Example Clause C, the computer-implemented method of any one of Example Clauses A through B, wherein the at least one transmittance level is further determined based on at least one of a positive relationship or an inverse relationship to the pupil diameter.

Example Clause D, the computer-implemented method of any one of Example Clauses A through C, further comprising: analyzing the image data to determine a shape of the at least one CGI; and determining, based at least in part on the shape of the at least one CGI, shape parameters to cause a profile of the at least one dimming mask to at least partially match the shape of the at least one CGI.

Example Clause E, the computer-implemented method of any one of Example Clauses A through D, further comprising: obtaining, from at least one light sensor, luminance-correlated data indicating at least a luminous intensity corresponding to the real-world view; and determining, based at least in part on the luminous intensity, opacity parameters that indicate at least one transmittance level that is less than a base transmittance of the transparent dimming panel, wherein the at least one dimming mask is driven to the at least one transmittance level.

Example Clause F, the computer-implemented method of any one of Example Clauses A through E, further comprising determining, based on the eye tracking data, a gaze direction corresponding to the at least one eye, wherein the at least one location parameter is further determined based on the gaze direction.

Example Clause G, the computer-implemented method of any one of Example Clauses A through F, wherein the at least one size parameter is further determined based on the image data.

While Example Clauses A through G are described above with respect to a method, it is understood in the context of this document that the subject matter of Example Clauses A through G can also be implemented by a device, by a system, and/or via computer-readable storage media.

Example Clause H, a Near-Eye-Display (NED) device, comprising: an eye tracking sensor to generate eye tracking data associated with at least one eye of a user; a transparent display having a first side that faces the at least one eye and a second side that faces a real-world object, the transparent display configured to cause a projection of at least one CGI outward from the first side; a transparent dimming panel that is positioned adjacent to the second side of the transparent display, the transparent dimming panel configured to generate at least one dimming mask to selectively block light from passing through at least one region of the transparent display; and at least one controller that is communicatively coupled to the eye tracking sensor, the transparent display, and the transparent dimming panel, wherein the at least one controller is configured to: receive image data that indicates at least one location on the transparent display to generate the at least one CGI; receive the eye tracking data from the eye tracking sensor, the eye tracking data indicating at least a pupil size corresponding to the at least one eye; determine for the at least one dimming mask: at least one size parameter based at least in part on the pupil size, at least one location parameter based at least in part on the at least one location, and at least one opacity parameter based at least in part on the pupil size; cause the transparent dimming panel to generate the at least one dimming mask according to the at least one size parameter, the at least one location parameter, and the at least one opacity parameter; and cause the transparent display to at least partially superimpose the at least one CGI with the at least one dimming mask to generate a composite view that includes the at least one CGI and at least a portion of the real-world view, wherein the at least one dimming mask blocks at least some light that is transmitted from the real-world object from passing through the at least one location on the transparent display.

Example Clause I, the NED device of Example Clause H, wherein the at least one dimming mask is generated directly between the real-world view and the at least one eye at a distance from at least one pupil, of the at least one eye, that is between 10 millimeters and 100 millimeters.

Example Clause J, the NED device of any of Example Clauses H through I, wherein the pupil size corresponds to a first area, and wherein the at least one size parameter causes the at least one dimming mask to mask a second area, of the transparent display, that is greater than or equal to the first area.

Example Clause K, the NED device of any of Example Clauses H through J, wherein the at least one controller is further configured to determine, for the at least one dimming mask, at least one shape parameter based at least in part on the image data.

Example Clause L, the NED device of any of Example Clauses H through K, wherein the at least one controller is further configured to: determine incident light parameters associated with at least one of a real light source corresponding to the real-world view or an augmented light source corresponding to an AR program, the incident light parameters indicating at least an incident light direction with respect to a rendered object; and based at least in part on the incident light parameters, determine, for the at least one dimming mask, a shadow protrusion to generate an augmented drop-shadow in association with the rendered object.

Example Clause M, the NED device of any of Example Clauses H through L, wherein the at least one eye comprises a first eye having a first pupil and a second eye having a second pupil, and wherein the at least one dimming mask comprises a first dimming mask disposed between the real-world object and the first pupil and a second dimming mask disposed between the real-world object and the second pupil.

Example Clause N, the NED device of any of Example Clauses H through M, wherein the at least one size parameter is further determined based on the image data.

Example Clause O, the NED device of any of Example Clauses H through N, wherein the at least one controller is further configured to monitor the eye tracking data to determine a gaze direction corresponding to the at least one eye, wherein at least one of the at least one size parameter or the at least one opacity parameter are further determined based on the gaze direction.

While Example Clauses H through O are described above with respect to a device, it is understood in the context of this document that the subject matter of Example Clauses H through O can also be implemented by a method, by a system, and/or via computer-readable storage media.

Example Clause P, a computer-implemented method, comprising: receiving image data that defines at least one CGI; monitoring a pupil diameter of at least one eye based on eye tracking data that is generated by at least one sensor; causing a transparent display to generate the at least one CGI at one or more locations, on the transparent display, that are between the at least one eye and a real-world object that is visible within a real-world view; determining at least one size parameter associated with at least one dimming mask based at least in part on the pupil diameter; and causing generation of the at least one dimming mask in accordance with the at least one size parameter to affect contrast between the at least one CGI and the real-world view, wherein the at least one dimming mask blocks at least some light that is transmitted from the real-world object from passing through the transparent display.

Example Clause Q, the computer-implemented method of Example Clause P, wherein the at least one dimming mask is at least partially aligned with the one or more locations to block the at least some light that is transmitted from the real-world object from passing through the at least one CGI at the one or more locations on the transparent display.

Example Clause R, the computer-implemented method of any one of Example Clauses P through Q, wherein the at least one dimming mask is driven to a predetermined transmittance level.

Example Clause S, the computer-implemented method of any one of Example Clauses P through R, wherein the at least one dimming mask is generated at a distance from at least one pupil, of the at least one eye, that is between 10 millimeters and 100 millimeters.

Example Clause T, the computer-implemented method of any one of Example Clauses P through S, further comprising: monitoring the eye tracking data to identify a change to the pupil diameter; and based on the change corresponding to an increase to the pupil diameter, increasing an area of the at least one dimming mask; or based on the change corresponding to a decrease to the pupil diameter, decreasing the area of the at least one dimming mask.

While Example Clauses P through T are described above with respect to a method, it is understood in the context of this document that the subject matter of Example Clauses P through T can also be implemented by a device, by a system, and/or via computer-readable storage media.

Example Clause U, a system for dynamically modifying dimming mask opacity, the system comprising: at least one sensor to generate eye tracking data associated with at least one eye; a transparent display having a first side that faces the at least one eye and a second side that faces a real-world object; a transparent dimming panel to generate at least one dimming mask at one or more locations of the transparent display, wherein the at least one dimming mask controls an amount of light, reflected off the real-world object, that passes through the one or more locations of the transparent display; and at least one controller that is communicatively coupled to the at least one sensor, the transparent display, and the transparent dimming panel, wherein the at least one controller is configured to: receive image data indicating at least one CGI; receive the eye tracking data from the at least one sensor, the eye tracking data indicating at least a pupil size corresponding to the at least one eye; determine, based at least in part on the pupil size, at least one transmittance level for the at least one dimming mask; cause the transparent dimming panel to generate the at least one dimming mask by driving at least one region, of the transparent dimming panel, to the at least one transmittance level; and cause the transparent display to generate a composite view that includes the at least one CGI and at least a portion of a real-world view, wherein the at least one dimming mask blocks at least some light that is transmitted from the real-world object from passing through the transparent display.

Example Clause V, the system of Example Clause U, wherein the at least one controller is configured to determine at least one position on the transparent dimming panel to generate the at least one dimming mask based at least in part on the image data.

Example Clause W, the system of any one of Example Clauses U through V, wherein the eye tracking data further indicates a gaze direction corresponding to the at least one eye, and wherein the at least one position is further determined based at least in part on the gaze direction.

Example Clause X, the system of any one of Example Clauses U through W, wherein the at least one CGI generated by the transparent display is at least partially aligned with the at least one dimming mask generated by the transparent dimming panel.

Example Clause Y, the system of any one of Example Clauses U through X, wherein the transparent dimming panel includes at least a functional area having transmittance level control capabilities, and wherein the at least one region corresponds to substantially all of the functional area having the transmittance level control capabilities.

Example Clause Z, the system of any one of Example Clauses U through Y, wherein the at least one controller is further configured to: determine, based on the image data, at least one profile corresponding to the at least one CGI; and determine shape parameters for the at least one dimming mask to at least partially position at least one user-perceived penumbra, corresponding to the at least one dimming mask, with respect to the at least one profile.

While Example Clauses U through Z are described above with respect to a system, it is understood in the context of this document that the subject matter of Example Clauses U through Z can also be implemented by a device, via a computer-implemented method, and/or via computer-readable storage media.

Example Clause AA, a computer-implemented method, comprising: receiving eye tracking data from at least one sensor that is positioned to monitor physical characteristics of at least one eye, wherein the eye tracking data indicates at least a pupil size and a gaze direction corresponding to the at least one eye; determining, based at least in part on the pupil size, at least one transmittance level for at least one dimming mask; determining, based at least in part on the gaze direction, at least one position on a transparent dimming panel to generate the at least one dimming mask; and causing the transparent display to generate the at least one dimming mask by driving a region, of the transparent display, that corresponds to the at least one position to the at least one transmittance level, wherein the at least one dimming mask blocks at least some light that is transmitted from a real-world object from passing through the transparent dimming panel.

Example Clause BB, the computer-implemented method of Example Clause AA, further comprising determining, based on the pupil size, at least one size parameter for the at least one dimming mask, wherein the at least one pupil corresponds to a first area and the at least one size parameter causes the at least one dimming mask to have a second area that is between one to three times the first area.

Example Clause CC, the computer-implemented method of any one of Example Clauses AA through BB, further comprising: monitoring the eye tracking data to identify a change to the gaze direction; and determining, based at least in part on the change to the gaze direction, at least one new position on the transparent dimming panel to move the at least one dimming mask to.

While Example Clauses AA through CC are described above with respect to a method, it is understood in the context of this document that the subject matter of Example Clauses AA through CC can also be implemented by a device, by a system, and/or via computer-readable storage media.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A computer-implemented method, comprising:
receiving image data indicating at least one location on a transparent display to generate at least one computer generated image (CGI);
obtaining, from at least one eye tracking sensor, eye tracking data associated with at least one eye that is positioned for viewing a real-world view, the eye tracking data indicating at least a pupil diameter of the at least one eye;
causing the transparent display to generate the at least one CGI at the at least one location, wherein the at least one location is positioned on the transparent display between the at least one eye and a real-world object that is visible within the real-world view;
determining at least one opacity parameter associated with modulating a proportion of light from the real-world object that propagates through a transparent dimming panel based on the pupil diameter to generate at least one dimming mask, the at least one dimming mask for enhancing contrast between the at least CGI and the real-world view; and
determining, based at least in part on the at least one location of the image data, at least one location parameter associated with the at least one dimming mask; and
causing, based on the at least one opacity parameter and the at least one location parameter, the transparent dimming panel to generate the at least one dimming mask with respect to the at least one location on the transparent display, wherein the at least one dimming mask blocks at least some of the light that is transmitted from the real-world object from passing through the at least one location on the transparent display toward at least one pupil of the at least one eye.

2. The computer-implemented method of claim 1, wherein the at least one dimming mask corresponds to at least one transmittance level is less than a base transmittance of the transparent dimming panel.

3. The computer-implemented method of claim 1, wherein the the proportion of light from the real-world object that propagates through the transparent dimming panel is determined based on at least one of a positive relationship to the pupil diameter or an inverse relationship to the pupil diameter.

4. The computer-implemented method of claim 1, further comprising:
analyzing the image data to determine a shape of the at least one CGI; and
determining, based at least in part on the shape of the at least one CGI, shape parameters to cause a profile of the at least one dimming mask to at least partially match the shape of the at least one CGI.

5. The computer-implemented method of claim 1, further comprising obtaining, from at least one light sensor, luminance-correlated data indicating at least a luminous intensity corresponding to the real-world view, wherein the determining the at least one opacity parameter is further based at least in part on the luminous intensity.

6. The computer-implemented method of claim 1, further comprising determining, based on the eye tracking data, a gaze direction corresponding to the at least one eye, wherein the at least one location parameter is further determined based on the gaze direction.

7. The computer-implemented method of claim 1, wherein the at least one opacity parameter is further determined based on the image data.

8. A Near-Eye-Display (NED) device, comprising:
an eye tracking sensor to generate eye tracking data associated with at least one eye of a user;
a transparent display having a first side that faces the at least one eye and a second side that faces a real-world object, the transparent display configured to cause a projection of at least one CGI outward from the first side;
a transparent dimming panel that is positioned adjacent to the second side of the transparent display, the transparent dimming panel configured to generate at least one dimming mask to selectively block light from passing through at least one region of the transparent display; and
at least one controller that is communicatively coupled to the eye tracking sensor, the transparent display, and the transparent dimming panel, wherein the at least one controller is configured to:
receive image data that indicates at least one location on the transparent display to generate the at least one CGI;
receive the eye tracking data from the eye tracking sensor, the eye tracking data indicating at least a pupil size corresponding to the at least one eye;
determine for the at least one dimming mask
at least one location parameter based at least in part on the at least one location, and
at least one opacity parameter associated with modulating a proportion of light from a real-world view that propagates through the transparent dimming panel at the at least one dimming mask based at least in part on the pupil size;
cause the transparent dimming panel to generate the at least one dimming mask according to the at least one location parameter, and the at least one opacity parameter; and
cause the transparent display to at least partially superimpose the at least one CGI with the at least one dimming mask to generate a composite view that includes the at least one CGI and at least a portion of the real-world view, wherein the at least one dimming mask blocks at least some light that is transmitted from the real-world object from passing through the at least one location on the transparent display.

9. The NED device of claim 8, wherein the at least one dimming mask is generated directly between the real-world view and the at least one eye at a distance from at least one pupil, of the at least one eye, that is between 10 millimeters and 100 millimeters.

10. The NED device of claim 8, wherein the pupil size corresponds to a first area, and wherein at least one size parameter causes the at least one dimming mask to mask a second area, of the transparent display, that is greater than or equal to the first area.

11. The NED device of claim 8, wherein the at least one controller is further configured to determine, for the at least one dimming mask, at least one shape parameter based at least in part on the image data.

12. The NED device of claim 8, wherein the at least one controller is further configured to:
determine incident light parameters associated with at least one of a real light source corresponding to the real-world view or an augmented light source corresponding to an AR program, the incident light parameters indicating at least an incident light direction with respect to a rendered object; and
based at least in part on the incident light parameters, determine, for the at least one dimming mask, a shadow protrusion to generate an augmented drop-shadow in association with the rendered object.

13. The NED device of claim 8, wherein the at least one eye comprises a first eye having a first pupil and a second eye having a second pupil, and wherein the at least one dimming mask comprises a first dimming mask disposed between the real-world object and the first pupil and a second dimming mask disposed between the real-world object and the second pupil.

14. The NED device of claim 8, wherein the at least one controller is further configured to determine at least one size parameter based on the image data.

15. The NED device of claim 8, wherein the at least one controller is further configured to monitor the eye tracking data to determine a gaze direction corresponding to the at least one eye, wherein the at least one opacity parameter are further determined based on the gaze direction.

16. A computer-implemented method, comprising:
receiving image data that defines at least one CGI;
monitoring a pupil diameter of at least one eye based on eye tracking data that is generated by at least one sensor;
causing a transparent display to generate the at least one CGI at one or more locations, on the transparent display, that are between the at least one eye and a real-world object that is visible within a real-world view;
determining at least one opacity parameter associated with generating at least one dimming mask by modulating a proportion of light from the real-world view that propagates through a transparent dimming panel based at least in part on the pupil diameter; and
causing generation of the at least one dimming mask in accordance with the at least one opacity parameter to affect contrast between the at least one CGI and the real-world view, wherein the at least one dimming mask blocks at least some light that is transmitted from the real-world object from passing through the transparent display.

17. The computer-implemented method of claim 16, wherein the at least one dimming mask is at least partially aligned with the one or more locations to block the at least some light that is transmitted from the real-world object from passing through the at least one CGI at the one or more locations on the transparent display.

18. The computer-implemented method of claim 16, wherein the at least one dimming mask is driven to a transmittance level that is determined based on the opacity parameter and a luminous intensity of the real-world view.

19. The computer-implemented method of claim 16, wherein the at least one dimming mask is generated at a distance from at least one pupil, of the at least one eye, that is between 10 millimeters and 100 millimeters.

20. The computer-implemented method of claim 16, further comprising:
monitoring the eye tracking data to identify a change to the pupil diameter; and
based on the change corresponding to an increase to the pupil diameter, decreasing the proportion of the light from the real-world view that propagates through of the at least one dimming mask; or
based on the change corresponding to a decrease to the pupil diameter, increasing the proportion of the light from the real-world view that propagates through of the at least one dimming mask.
